(19) United States
(12) Patent Application Publication
(10) Pub. No.: US 2023/0167227 A1
(43) Pub. Date: Jun. 1, 2023

(54) AQUEOUS DISPERSION OF POLY(ESTER-URETHANE) OR OF POLY(ESTER-URETHANE-UREA)

(71) Applicant: Arkema France, Colombes (FR)

(72) Inventors: Sylvain BEAUDRAIS, Verneuil En Halatte (FR); Christophe DEQUENNE, Verneuil En Halatte (FR)

(21) Appl. No.: 17/921,190

(22) PCT Filed: Apr. 28, 2021
(86) PCT No.: PCT/EP2021/061202

§ 371 Date: Oct. 25, 2022

(30) Foreign Application Priority Data
Apr. 28, 2020 (FR) FR2004209

(51) Int. Cl. C08G 18/46; C08G 63/183; C08G 63/688; C08G 18/12; C08G 18/42; C08G 18/32; C09D 175/02; C09D 175/06

(52) U.S. Cl. CPC C08G 18/4676; C08G 63/183; C08G 63/688; C08G 18/12; C08G 18/4211; C08G 18/3228; C09D 175/02; C09D 175/06; C08G 2150/00; C08G 2170/00; C08G 2190/00

(57) ABSTRACT

The present invention relates to a poly(ester-urethane), to a poly(ester-urea-urethane), and also to aqueous dispersions of these and to their uses in aqueous coatings, adhesives or sealants, in particular as binder in paints or varnishes.

### SUMMARY OF THE INVENTION

The invention relates to a poly(ester-urethane), to a poly(ester-urea-urethane), and also to aqueous dispersions of these and to their uses in aqueous coatings, adhesives or sealants, in particular as binder in paints or varnishes.

### TECHNICAL BACKGROUND

Polyester resins are resins obtained by reacting polyacids and polyols. Polyester resins can be modified by adding a fatty component derived from an oil to form a particular type of polyester resins: alkyd resins. Alkyd resins have been used for more than 50 years to form coatings, in particular decorative and industrial paints. There are also oil-free polyester resins (or OFPEs).

The difference between alkyd resins and oil-free polyester resins is the presence or absence of a fatty component. The fatty component confers flexibility, gloss and a good water resistance to the coating obtained. When the fatty component includes unsaturations, the alkyd resins may dry by auto-oxidation (siccativation). The absence of fatty component confers a weak coloration to the resin, good chemical resistance and excellent hardness.

A polyester can be modified, in particular by urethane and/or urea bonds to result in poly(ester-urethanes) or poly(ester-urea-urethanes), in order to improve the properties of the coatings obtained, in particular to obtain a good substrate adhesion, good flexibility, good abrasion resistance, excellent self-adhesion (blocking) resistance and good mechanical strength in general.

Polyester resins in an organic solvent medium, also called solvent-based polyester resins, have been known to those skilled in the art for a long time and are generally used in coatings and decorative and industrial paint formulations. To respond to issues of use comfort, odor and toxicity, specific polyester emulsions have been developed and marketed over the last 20 or so years, with advantageous performance levels in terms of gloss, drying, appearance/color, stability and odor.

Poly(ester-urethane) or poly(ester-urea-urethane) dispersions can be obtained using surfactants or else by introducing ionizable groups, in particular carboxylic acid groups, along the polymer backbone. There are several processes for preparing a poly(ester-urethane) dispersion, notably the solvent-assisted dispersion process as described in WO 2008/086977. This process consists in preparing an alkyd intermediate in an organic water-miscible solvent having a low boiling point, such as acetone, and reacting it with a polyisocyanate to form a prepolymer. The water is added gradually and the organic solvent is evaporated to form an aqueous poly(ester-urethane) dispersion. The use of an organic solvent makes it possible to control the rise in viscosity during the preparation of the prepolymer. However, the step of evaporating the organic solvent is costly and requires specific installations. In addition, this process can only be used to manufacture acetone-soluble poly(ester-urethanes). Consequently, the coatings obtained are not very resistant to solvents.

Also known are processes for elongating alkyds in aqueous phase with diisocyanates, as described in WO 02/31021. However, the coatings obtained with these dispersions are unsatisfactory in terms of hardness and drying time.

There is a need for a VOC-free poly(ester-urethane) or poly(ester-urea-urethane) dispersion that does not involve the use of an organic solvent during its preparation process and has good properties in terms of gloss, hardness, substrate adhesion, flexibility, abrasion resistance, self-adhesion (blocking) resistance, mechanical strength, drying, appearance/color, stability and odor. In certain cases, the dispersions according to the invention will be able to be used in applications relating to temporary-use or temporary-function coatings or materials, that is to say those which can easily be removed after performing a temporary function, for example by simple cleaning with water or saline water or another aqueous solution, in particular having a pH >7 and preferably >8, optionally while heating. Examples of such applications are water-soluble inks, adhesives for labels, water-fragmentable support materials for 3D printing (also called sacrificial materials) or encapsulation.

### DISCLOSURE OF THE INVENTION

The poly(ester-urethanes) and the poly(ester-urea-urethanes) of the invention enable the preparation of aqueous poly(ester-urethane) and poly(ester-urea-urethane) dispersions which meet the needs or overcome the abovementioned disadvantages.

The solution of the invention is first of all a solution that is friendly for those skilled in the art and for their environment as a result of the absence of organic solvents, resulting in a low content of VOCs in the aqueous dispersion, possibly in the absence of siccative agent, such as metal salts (cadmium, tin, cobalt, manganese, zirconium, lead and calcium).

Thus, the specific poly(ester-urethanes) and poly(ester-urea-urethanes) of the invention make possible these dispersions and associated technical performance properties, in particular the rapid development of hardness after application and a reduction in the yellowing. They may be used as binder in aqueous air-curable decorative or industrial coating compositions.

Subject Matter of the Invention

A first subject of the invention relates to a poly(ester-urethane) comprising:
isocyanate functions;
acid groups having a pKa of less than 3, optionally in partially or completely neutralized form;
optionally saturated fatty chains and/or unsaturated fatty chains;
ester and urethane bonds;
optionally an amide bond; and
optionally a urea bond.

The invention also relates to a poly(ester-urea-urethane) comprising:
acid groups having a pKa of less than 3, optionally in partially or completely neutralized form;
optionally saturated fatty chains and/or unsaturated fatty chains;
ester, urea and urethane bonds; and
optionally an amide bond.

Next, the invention relates to an aqueous dispersion comprising the poly(ester-urethane) according to the invention or the poly(ester-urea-urethane) according to the invention, the acid groups of the poly(ester-urethane) or of the poly(ester-urea-urethane) being in partially or completely neutralized form.

The invention more particularly relates to a process for preparing an aqueous dispersion, comprising the following steps:
preparing a polyol P1 comprising an acid group having a pKa of less than 3, optionally in partially or completely neutralized form, and optionally a saturated fatty chain and/or an unsaturated fatty chain, or preparing a polyol P2 comprising an acid group having a pKa of less than 3, optionally in partially or completely neutralized form, and a polyol P3 comprising a saturated fatty chain and/or an unsaturated fatty chain;
preparing a poly(ester-urethane) by polyaddition of at least one polyisocyanate, at least one polyol P1 and optionally another polyol P4 and/or a fatty component CG or by polyaddition of at least one polyisocyanate, at least one polyol P2, at least one polyol P3 and optionally another polyol P4 and/or a fatty component CG, the polyaddition being effected with an NCO/(OH+optional amine) ratio of greater than 1, in particular from 1.1 to 3, more particularly from 1.5 to 2;
optionally partially or completely neutralizing the acid groups of the poly(ester-urethane) by addition of a base, in particular a base chosen from a tertiary amine and a metal hydroxide, more particularly an alkali metal hydroxide;
dispersing the poly(ester-urethane) in water, in particular by gradual addition of water to said poly(ester-urethane) and phase inversion or by addition of the poly(ester-urethane) to water;
optionally conducting an elongation reaction of the poly(ester-urethane), optionally in the presence of at least one polyamine having a functionality ranging from 2 to 6, in particular from 2.25 to 6, more particularly from 2.5 to 6, more particularly still from 3 to 6, the molar ratio between the amine functions of the optional polyamine component and the isocyanate functions of the poly(ester-urethane) being from 0.01 to 3, in particular from 0.2 to 1.5, more particularly from 0.5 to 1.

The invention also relates to a coating, adhesive or sealant composition comprising a poly(ester-urethane) and/or a poly(ester-urea-urethane) and/or an aqueous dispersion according to the invention.

A further subject of the invention is the use of a poly(ester-urethane) and/or a poly(ester-urea-urethane) and/or an aqueous dispersion according to the invention as binder, in particular as binder in a coating, adhesive or sealant composition.

Lastly, the invention also relates to a coating, adhesive or sealant obtained by application and drying of the composition according to the invention.

### Definitions

In the present patent application, the terms “comprises a” and “comprises an” mean “comprises one or more”.

Unless otherwise mentioned, the percentages by weight in a compound or a composition are expressed relative to the weight of the compound or of the composition.

The term “polyol” means a compound having at least two hydroxyl functions. The functionality of a polyol corresponds to the number of hydroxyl functions that it contains.

The term “polyester” means a compound comprising at least two ester bonds. A polyester may also include another bond, in particular an amide bond.

The term “polyester polyol” means a polyester comprising at least two hydroxyl functions. A polyester polyol may also include another functional group, in particular an amide function.

The term “fatty acid” means a compound comprising a carboxylic acid function or an ester bond, and a hydrocarbyl chain having from 6 to 60, in particular 8 to 55, more particularly 10 to 50, consecutive carbon atoms. A saturated fatty acid is a fatty acid not comprising any C═C double bonds. An unsaturated fatty acid comprises a C═C double bond. The hydrocarbyl chain may be substituted, in particular by one or more hydroxyl or carbonyl functions. The fatty acid can be an unsaturated fatty monoacid or a fatty acid dimer. The unsaturated fatty acid derivatives that can generate unsaturated fatty acids by hydrolysis or transesterification are included under the term “unsaturated fatty acid”. These derivatives notably include unsaturated fatty acid esters (in particular triglycerides), stand oils and estolides.

The term “monoacid” means a compound comprising a single carboxylic acid function. A C₂-C₁₀ monoacid means a monoacid comprising from 2 to 10 carbon atoms. The monoacid derivatives that can generate a monoacid by hydrolysis or transesterification are included under the term “monoacid”. These derivatives include in particular esters of monoacids.

The term “hydrocarbyl chain” means a monovalent or polyvalent radical comprising carbon and hydrogen atoms. A hydrocarbyl chain can in particular comprise 1 to 200 carbon atoms. Unless mentioned otherwise, a hydrocarbyl chain may be substituted. Unless mentioned otherwise, a hydrocarbyl chain may be interrupted by one or more heteroatoms chosen from O, N, S and Si. A hydrocarbyl chain having from 11 to 53 consecutive carbon atoms means a hydrocarbyl chain comprising a sequence of from 11 to 53 carbon atoms without any interruption by heteroatoms (O, N, S and Si).

The term “poly(ester-urethane)” means a polyester polyol in which the hydroxyl functions have been modified by reaction with a polyisocyanate to form urethane bonds (—O—C(═O)—NH— or —NH—C(═O)—O—), the poly(ester-urethane) comprising residual isocyanate functions.

The term “poly(ester-urea-urethane)” means a product obtained by formation of urea bonds between the isocyanate functions of a poly(ester-urethane). The formation of urea bonds can be achieved in water, optionally in the presence of a polyamine component.

The term “hydroxyl function” means an —OH function.

The term “glycidyl function” means an epoxide function

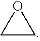

The term “thiol function” means an —SH function. The term mercapto may also be used to denote a thiol function.

The term “carbonyl function” means a —C(═O)— function.

The term “carboxylic acid function” means a —COOH function.

The term “isocyanate function” means an —N═C═O function.

The term “ester function” means a —C(═O)—O—Y function, Y being a hydrocarbyl chain.

The term “amide function” means a —C(═O)—NH₂ or —C(═O)—NH—(C₁-C₆ alkyl) function.

The term “anhydride function” means a —C(═O)—O—C(═O)—(C₁-C₆ alkyl) function.

The term “amine function” means a primary amine (—NH₂) and/or secondary amine (—NHR₁ with R₁ being C₁-C₆ alkyl) function. The —NH— group of an amide, urea or urethane bond is not considered to be an amine function. A tertiary amine is not considered to be an amine function.

The term “alkyl” means a saturated monovalent acyclic radical of formula —CₙH₂ₙ₊₁. An alkyl can be linear or branched. A C₁-C₆ alkyl means an alkyl comprising 1 to 6 carbon atoms.

The term “alkenyl” means a monovalent acyclic radical having one or more C═C double bonds. An alkenyl can be linear or branched. A C₆-C₆₀ alkenyl means an alkenyl comprising from 6 to 60 carbon atoms.

The term “alkoxy” means an —O-alkyl radical.

The term “ester bond” means a —C(═O)—O— or —O—C(═O)— bond.

The term “urethane bond” means an —NH—C(═O)—O— or —O—C(═O)—NH— bond.

The term “amide bond” means a —C(═O)—NH— or —NH—C(═O)— bond.

The term “urea bond” means an —NH—C(═O)—NH— bond.

The term “substituted” signifies the replacement of one or more hydrogen atoms by a group or a function independently chosen from alkyl, hydroxyl, alkoxy, glycidyl, halogen (Br, Cl, I), nitrile, isocyanate, carbonyl, amine, carboxylic acid, ester, anhydride, a sulfonylated group (—S(═O)₂OR), a phosphonylated group (—P(═O)(OR)₂), a sulfated group (—O—S(═O)₂OR) and a phosphated group (—O—P(═O)(OR)₂), each R independently being a hydrogen atom, a metal salt or a hydrocarbyl chain and mixtures thereof.

The term “fatty chain” means a hydrocarbyl chain having 6 to 60, in particular 8 to 55, more particularly 10 to 50, consecutive carbon atoms. A fatty chain may be saturated, that is to say that it does not comprise any C═C double bonds, or a fatty chain may be unsaturated, that is to say that it comprises a C═C double bond. A fatty chain may be substituted, in particular by one or more hydroxyl and/or glycidyl groups.

The term “acid group” means a group which can be anionized by loss of a proton, in particular by reaction with a base. For example, a sulfonic acid group (—S(═O)₂—OH) can be transformed into a sulfonate group (—S(═O)₂—O—) by reaction with a base. Examples of suitable bases are a tertiary amine, a metal hydroxide, an alkoxide and a quaternary ammonium, in particular an alkali metal hydroxide, more particularly KOH, LiOH and NaOH. The term “acid group” includes the partially or completely salified or esterified forms of said acid groups, in particular the sodium, potassium, lithium, calcium, magnesium and aluminum salts of said groups and also the mono- and dialkyl esters of said groups.

The term “graftable function” means a function chosen from hydroxyl, glycidyl, thiol, amine, carboxylic acid, isocyanate, ester, amide and anhydride.

The term “isocyanate-reactive function” means a function chosen from hydroxyl, thiol and amine.

The term “aqueous dispersion” means a polyphasic system having a dispersed organic phase and a continuous aqueous phase.

The term “solvent” means a liquid having the property of dissolving, diluting or lowering the viscosity of other substances without chemically modifying them and without itself being modified. Examples of solvents are water, acetone, methyl ethyl ketone, dimethylformamide, ethylene glycol dimethyl ether, N-methylpyrrolidone, ethyl acetate, butyl acetate, ethyl 3-ethoxypropionate, ethylene and propylene glycol diacetates, ethylene and/or propylene glycol alkyl ethers (for example 1-methoxy-2-propanol), toluene, xylene, ethanol, methanol, tert-butanol, diacetone alcohol, isopropanol, mixtures of hydrocarbons such as heavy naphtha (white spirit), light aromatic naphtha (Solvesso® 100) or heavy aromatic naphtha (Solvesso® 150). Components a1), a2), a3), b), c), d), P1, P2, P3, P4, CG, PE1, PE2, PE3 as defined above are not considered to be solvents.

The term “polyaddition” means a reaction between compounds bearing at least two functional groups. In contrast to polycondensation, polyaddition does not generate water. One example of polyaddition is the reaction between a compound bearing hydroxyl and/or amine functions and a compound bearing isocyanate functions to form urethane and/or urea bonds.

The term “polycondensation” means a reaction between compounds bearing at least two functional groups with the concomitant formation of water. One example of polycondensation is the reaction between a compound bearing hydroxyl and/or amine functions and a compound bearing carboxylic acid functions to form ester and/or amide bonds.

The term “polyisocyanate” means a compound having at least two isocyanate functions. The functionality of a polyisocyanate corresponds to the number of isocyanate functions that it contains.

The term “aliphatic” means a non-aromatic acyclic compound. It can be linear or branched, saturated or unsaturated and substituted or unsubstituted. It may comprise one or more bonds/functions, for example chosen from ether, ester, amide, urethane, urea, and mixtures thereof.

The term “cycloaliphatic” means a non-aromatic compound comprising a ring. It can be substituted or unsubstituted. It can comprise one or more bonds/functions as defined for the term “aliphatic”.

The term “aromatic” means a compound comprising an aromatic ring, that is to say obeying Hückel's rule of aromaticity, in particular a compound comprising a phenyl group. It can be substituted or unsubstituted. It can comprise one or more bonds/functions as defined for the term “aliphatic”.

The term “saturated” means a compound which does not comprise a carbon-carbon double or triple bond.

The term “unsaturated” means a compound which comprises a carbon-carbon double or triple bond, in particular a carbon-carbon double bond.

The term “cyclic anhydride” means a cyclic compound comprising a —C(═O)—O—C(═O)— bond.

The term “polyacid” means a compound comprising at least two carboxylic acid functions. The functionality of a polyacid corresponds to the number of carboxylic acid functions that it contains. The polyacid derivatives that can generate a polyacid by hydrolysis or transesterification are included under the term “polyacid”. These derivatives include in particular esters of polyacids.

The term “polycarbonate” means a compound comprising at least two carbonate bonds.

The term “polycarbonate polyol” means a polycarbonate comprising at least two hydroxyl functions.

The term “polyorganosiloxane” means a compound comprising at least two Si—O—Si bonds.

The term “polyorganosiloxane polyol” means a polyorganosiloxane comprising at least two hydroxyl functions.

The term “polyamine” means a compound having at least two amine functions. The functionality of a polyamine corresponds to the number of amine functions that it contains.

The term “volatile compound” means a compound having a vapor pressure of 0.01 kPa or more at a temperature of 20° C.

### DETAILED DESCRIPTION

Poly(Ester-Urethane)

The poly(ester-urethane) according to the invention comprises:
isocyanate functions;
acid groups having a pKa of less than 3, optionally in partially or completely neutralized form;
optionally saturated fatty chains and/or unsaturated fatty chains;
ester and urethane bonds.

The poly(ester-urethane) according to the invention can in particular correspond to a mixture of poly(ester-urethanes) or to a distribution of poly(ester-urethanes) having a different number of isocyanate functions, of acid groups having a pKa of less than 3, of ester bonds and of urethane bonds.

According to one particular embodiment, the poly(ester-urethane) may additionally comprise an amide bond and/or a urea bond.

The poly(ester-urethane) according to the invention comprises isocyanate functions. The content of isocyanate functions in the poly(ester-urethane) can in particular be estimated by the NCO number. According to one embodiment, the poly(ester-urethane) can have an NCO number of from 20 to 250 mg KOH/g, preferably 30 to 200 mg KOH/g, more particularly 50 to 150 mg KOH/g. The NCO number can in particular be measured according to the method described below.

According to one particular embodiment, the poly(ester-urethane) according to the invention is substantially devoid of hydroxyl functions. The content of hydroxyl functions in the poly(ester-urethane) can in particular be estimated by the OH number. According to one embodiment, the poly(ester-urethane) can have an OH number of less than 20 mg KOH/g, in particular of less than 10 mg KOH/g, more particularly of less than 1 mg KOH/g, more particularly still of less than 0.1 mg KOH/g. The OH number can in particular be measured according to the method described below.

The poly(ester-urethane) according to the invention can comprise saturated fatty chains and/or unsaturated fatty chains. According to one particular embodiment, the poly(ester-urethane) can have a content of saturated fatty chains and/or unsaturated fatty chains of 0%. It is then said that the poly(ester-urethane) has zero oil content (oil-free polyester). According to one particular embodiment, the poly(ester-urethane) can have a content of saturated fatty chains and/or unsaturated fatty chains of at least 5%, in particular from 10 to 60%, more particularly from 15 to 40%, relative to the total weight of the poly(ester-urethane). The content of saturated fatty chains and/or unsaturated fatty chains can in particular be calculated according to the method described below. It is then said that the poly(ester-urethane) is an alkyd-urethane.

The poly(ester-urethane) according to the invention comprises acid groups having a pKa of less than 3, optionally in partially or completely neutralized form. The acid groups having a pKa of less than 3 may in particular make it possible to achieve an aqueous phase self-emulsification of the poly(ester-urethane). The choice of a pKa of less than 3 for the acid group excludes carboxylic acid (—COOH) and carboxylate (—COO⁻) groups. According to one particular embodiment, the acid groups having a pKa of less than 3 are chosen from a sulfonylated group (—S(═O)₂OR), a phosphonylated group (—P(═O)(OR)₂), a sulfated group (—O—S(═O)₂OR), a phosphated group (—O—P(═O)(OR)₂), and mixtures thereof, each R independently being a hydrogen atom, a metal salt or a hydrocarbyl chain. The sulfonylated, phosphonylated, sulfated and phosphated groups described above are bonded to a carbon atom. In particular, the poly(ester-urethane) can comprise acid groups chosen from a sulfonylated group and a phosphonylated group. More particularly, the acid group can be a sulfonylated group of the formula —S(═O)₂OR, each R independently being a hydrogen atom or a metal salt, in particular an alkali metal salt such as, for example, a sodium, potassium or lithium salt or a divalent salt such as, for example, a calcium, magnesium or aluminum salt.

Without wishing to be bound to any particular theory, the incorporation of acid groups having a pKa of less than 3 makes it possible to achieve a coating having good properties, in particular in terms of water resistance, hardness and drying time, while avoiding the use of volatile organic compounds (VOCs), in particular volatile amines such as triethylamine, for the neutralization of the acid groups. Thus, the compositions comprising the poly(ester-urethane) according to the invention can be considered to be free from VOCs.

The poly(ester-urethane) can in particular have a number-average molecular mass Mn of from 250 to 10 000 g/mol, in particular 500 to 7000 g/mol, more particularly 1000 to 5000 g/mol. The number-average molecular mass can in particular be measured according to the method described below. The choice of a number-average molecular mass within the above-mentioned ranges advantageously makes it possible to control the viscosity of the poly(ester-urethane). Thus, there is no need to add solvent during the preparation of the poly(ester-urethane).

The poly(ester-urethane) can notably comprise less than 10%, in particular less than 5%, more particularly less than 1%, more particularly still less than 0.1%, by weight of solvent.

The poly(ester-urethane) can notably comprise less than 10%, in particular less than 5%, more particularly less than 1%, more particularly still less than 0.1%, by weight of volatile amine, such as triethylamine.

The poly(ester-urethane) according to the invention can be obtained by polyaddition of one or more polyisocyanates and one or more polyols according to the process described below.

Process for Preparing the Poly(Ester-Urethane)

According to a first embodiment, the poly(ester-urethane) can be obtained by polyaddition of at least one polyisocyanate, at least one polyol P1 and optionally another polyol P4 and/or a fatty component CG, said polyol P1 comprising an acid group having a pKa of less than 3, optionally in partially or completely neutralized form, optionally a saturated fatty chain and/or an unsaturated fatty chain and optionally an amine function.

According to a second embodiment, the poly(ester-urethane) can be obtained by polyaddition of at least one polyisocyanate, at least one polyol P2, at least one polyol P3 and optionally another polyol P4 and/or a fatty component CG, said polyol P2 comprising an acid group having a pKa of less than 3, optionally in partially or completely neutralized form, and optionally an amine function, and said polyol P3 not comprising an acid group having a pKa of less than 3 but optionally comprising a saturated fatty chain and/or an unsaturated fatty chain and optionally an amine function.

In both embodiments described above, the polyaddition is effected with a molar ratio of the functions NCO/(OH+optional amine) of greater than 1, in particular from 1.1 to 3, more particularly from 1.5 to 2.

The excess of isocyanate functions during the polyaddition advantageously makes it possible to control the number-average molecular mass and also the viscosity of the poly(ester-urethane) without having to add solvent during the polyaddition. According to one particular embodiment, the polyaddition can be carried out in the absence of solvent, in particular in the absence of acetone and xylene. Thus, the reaction medium can in particular contain less than 10%, in particular less than 5%, more particularly less than 1%, more particularly still less than 0.1%, by weight of solvent, in particular acetone and xylene.

The polyaddition reaction can in particular be carried out by heating the reaction medium. For example, the temperature of the reaction medium may range from 50 to 200° C., in particular 80 to 170° C., more particularly from 90 to 130° C.

The various components can be reacted in a single step or in successive steps. For example, for the second embodiment, the polyol P2 and the polyisocyanate can be reacted in a first step and then this intermediate can be reacted with the polyol P3 in a second step.

The progress of the polyaddition can be monitored via the NCO number of the reaction mixture.

The polyisocyanate used to obtain the poly(ester-urethane) can in particular be a polyisocyanate having a functionality ranging from 2 to 3, in particular a diisocyanate. It is also possible to use a mixture of polyisocyanates. According to one embodiment, the polyisocyanate is chosen from an aliphatic, cycloaliphatic or aromatic polyisocyanate, in particular a cycloaliphatic polyisocyanate. It may in particular be a diisocyanate or a triisocyanate or a derivative of these isocyanates such as oligomers of diisocyanates or precondensates or prepolymers bearing isocyanate functions having a functionality ranging from 2 to 3. These polyisocyanates can optionally be in a form blocked by a blocking agent that is labile under the reaction conditions.

As examples of suitable polyisocyanates, mention may be made (without limitation) of the following: Toluene-2,4- and -2,6-diisocyanate (TDI), isophorone diisocyanate (IPDI) corresponding to 3-isocyanatomethyl-3,5,5-trimethylcyclohexyl isocyanate, tetramethylene diisocyanate, hexamethylene diisocyanate (HDI), trimethylhexamethylene diisocyanate (TMDI), diphenylmethane-4,4′-diisocyanate (MDI), dicyclohexylmethane-4,4′-diisocyanate (H12MDI), 3,3′-dimethyl-4,4′-biphenyl diisocyanate, benzene-1,4-diisocyanate, naphthalene-1,5-diisocyanate (NDI), cyclohexane-1,3- and -1,4-diisocyanate, 1-methyl-2,4-diisocyanatocyclohexane, 1-methyl-2,6-diisocyanatocyclohexane, dodecane diisocyanate, m-tetramethylxylylene diisocyanate, xylylene-4,6-diisocyanate, triisocyanatotoluene, a TDI trimer (such as Desmodur® R from Bayer), an HDI trimer (such as Desmodur® N from Bayer), and mixtures thereof.

According to one embodiment, the polyisocyanate is a diisocyanate, in particular a cycloaliphatic diisocyanate, more particularly isophorone diisocyanate (IPDI), cyclohexane-1,4-diisocyanate, dicyclohexylmethane-4,4′-diisocyanate (H12MDI), and mixtures thereof, more particularly still isophorone diisocyanate.

According to one particular embodiment, the polyol P1 or the polyols P2 and P3 used to obtain the poly(ester-urethane) are polyester polyols. Thus, P1, P2 and/or P3 may comprise ester bonds and hydroxyl functions. P1, P2 and/or P3 may also comprise additional substituents and/or bonds. For example, P1, P2 and/or P3 may comprise an element chosen from an amine function, an amide bond, a urethane bond, and combinations thereof.

In particular, P1, P2 and/or P3 may comprise an amine function. When P1, P2 and/or P3 comprise an amine function, the resultant poly(ester-urethane) will comprise a urea bond. This is because, during the polyaddition, the amine function will react with the polyisocyanate to form a urea bond.

The polyol P1 comprises an acid group having a pKa of less than 3, optionally in partially or completely neutralized form, and optionally a saturated fatty chain and/or an unsaturated fatty chain. The polyol P1 can in particular be a polyester polyol PE1 obtained by polycondensation of the following components:
a) an acid component comprising:
   a1) a compound chosen from a polyacid having a carboxylic acid functionality of from 2 to 3, a cyclic anhydride, and mixtures thereof; and
   a2) optionally a C₂-C₁₀ monoacid;
b) a polyol component comprising a polyol having a functionality ranging from 2 to 6;
c) optionally a chain extender comprising a graftable function and an isocyanate-reactive function;
d) a hydrophilic compound comprising an acid group having a pKa of less than 3, optionally in partially or completely neutralized form, and a graftable function; and
e) optionally a fatty component comprising a graftable function and a saturated fatty chain and/or an unsaturated fatty chain.

The polycondensation can be carried out by reacting the various components in a single step or in successive steps. For example, component b) and component d) can be reacted in a first step, and then this intermediate can be reacted with component a1) in a second step, and then optionally this intermediate can be reacted with component e) in a third step. Of course, the sequence in which the various reactants are introduced can be varied.

The polycondensation can be carried out in the absence of solvent other than water, in particular in the absence of acetone and xylene. Thus, the reaction medium can in particular contain less than 10%, in particular less than 5%, more particularly less than 1%, more particularly still less than 0.1%, by weight of solvent other than water, in particular acetone and xylene. More particularly, the reaction medium does not comprise any solvent other than the solvent that may be produced during the polycondensation.

The reaction medium can in particular be heated. For example, the temperature of the reaction medium may range from 100 to 300° C., in particular 150 to 250° C., more particularly from 200 to 230° C.

According to one particular embodiment, the water produced during the polycondensation is distilled as it is formed.

The progress of the polycondensation can be monitored via the acid number of the reaction mixture.

Component a1) used to make the polyol PE1 comprises a compound chosen from a polyacid having a carboxylic acid functionality of from 2 to 3, a cyclic anhydride, and mixtures thereof. Component a1) is different from components a2), b), c), d) and e).

The polyacid can in particular be unsaturated or saturated, in particular saturated. The polyacid can in particular be a dicarboxylic acid, a tricarboxylic acid, a monocarboxylic acid dimer, a monocarboxylic acid trimer, and mixtures thereof. The polyacid can notably comprise 3 to 54, in particular 4 to 20, more particularly 5 to 15, carbon atoms. According to one embodiment, the polyacid is an aliphatic, cycloaliphatic or aromatic polyacid. According to one embodiment, the polyacid is a saturated or unsaturated, preferably saturated, polyacid. In particular, the polyacid can be an aliphatic polyacid, more particularly a saturated or unsaturated aliphatic polyacid, more particularly still a saturated aliphatic polyacid.

Examples of saturated aliphatic polyacids are malonic acid (diacid), succinic acid (diacid), 2-methylsuccinic acid (diacid), 2,2-dimethylsuccinic acid (diacid), glutaric acid (diacid), 3,3-diethylglutaric acid (diacid), adipic acid (diacid), pimelic acid (diacid), suberic acid (diacid), azelaic acid (diacid), sebacic acid (diacid), dodecanedioic acid (diacid), citric acid (triacid), propane-1,2,3-tricarboxylic acid (triacid), a dimer of a saturated C₃₂ to C₃₆ fatty acid (having a functionality of from 2 to 2.2) or a trimer of a C₅₄ fatty acid (having a functionality of from 2.5 to 3).

Examples of unsaturated aliphatic polyacids are itaconic acid (diacid), maleic acid (diacid), fumaric acid (diacid), glutaconic acid (diacid) and muconic acid (diacid).

An example of a saturated cycloaliphatic polyacid is cyclohexanedicarboxylic acid.

An example of an unsaturated cycloaliphatic polyacid is tetrahydrophthalic acid (diacid).

Examples of aromatic polyacids are phthalic acid (diacid), isophthalic acid (diacid), terephthalic acid (diacid), naphthalenedicarboxylic acid, trimellitic acid (triacid), 2,5-furandicarboxylic acid.

The polyacid can be a polyacid derivative. Such a derivative can be transformed into polyacid by hydrolysis or transesterification. The polyacid derivatives include the partially or completely esterified forms of the polyacids defined above, in particular the C₁-C₆ alkyl mono-, di- and triesters of the polyacids defined above. The polyacid derivatives can notably comprise 5 to 60, in particular 6 to 25, more particularly 7 to 20, carbon atoms.

Examples of suitable polyacid derivatives are dimethyl malonate, diethyl malonate, dimethyl adipate, dimethyl glutarate and dimethyl succinate.

The cyclic anhydride can notably be saturated or unsaturated, in particular unsaturated. The unsaturated cyclic anhydride can notably be cycloaliphatic or aromatic, in particular aromatic.

Examples of saturated cyclic anhydrides are succinic anhydride and hexahydrophthalic anhydride. Examples of unsaturated cycloaliphatic anhydrides are maleic anhydride, fumaric anhydride and tetrahydrophthalic anhydride. An example of an aromatic anhydride is phthalic anhydride.

According to a particular embodiment, compound a1) comprises a dicarboxylic acid, more particularly a saturated aliphatic dicarboxylic acid, more particularly still adipic acid or sebacic acid.

According to a particular embodiment, compound a1) comprises a dicarboxylic acid derivative, more particularly a dimethyl or diethyl ester of a saturated aliphatic dicarboxylic acid, more particularly still dimethyl malonate or diethyl malonate.

According to one particular embodiment, compound a1) comprises a cyclic anhydride, more particularly an unsaturated cyclic anhydride, more particularly still an aromatic anhydride, especially phthalic anhydride.

The amount of component a1) used in the preparation of the polyol PE1 may notably range from 1 to 50%, in particular 5 to 40%, more particularly 10 to 30%, by weight relative to the total weight of compounds a1)+a2)+b)+c)+d)+e).

The component a2) that may possibly be used to make the polyol PE1 comprises a C₂-C₁₀ monoacid. It is also possible to use a mixture of C₂-C₁₀ monoacids. Component a2) is different from components a1), b), c), d) and e).

The monoacid can be an aliphatic, cycloaliphatic or aromatic, in particular aromatic, monoacid.

Examples of suitable C₂-C₁₀ monoacids are benzoic acid, tert-butylbenzoic acid, hexahydrobenzoic acid and 2-ethylhexanoic acid.

According to one particular embodiment, component a2) comprises an aromatic C₂-C₁₀ monoacid, more particularly benzoic acid.

The amount of component a2) used in the preparation of the polyol PE1 may notably range from 0 to 50%, in particular 0 to 30%, more particularly 0 to 20%, by weight relative to the total weight of compounds a1)+a2)+b)+c)+d)+e).

The component b) used to make the polyol PE1 comprises a polyol having a functionality of from 2 to 6. It is also possible to use a mixture of polyols having a functionality of from 2 to 6. Component b) is different from components a1), a2), c), d) and e).

According to one particular embodiment, the polyol has a functionality of from 2 to 4. The polyol can notably be an aliphatic, cycloaliphatic or aromatic, in particular aliphatic or cycloaliphatic, polyol. The polyol can in particular be a saturated polyol.

According to one embodiment, component b) comprises a branched diol, notably a diol bearing at least one methyl substituent, in particular two methyl substituents.

According to one embodiment, component b) comprises polyol having a functionality of from 3 to 4.

According to one embodiment, the polyol(s) of component b) have a molar mass of less than 400 g/mol, less than 350 g/mol, less than 300 g/mol, less than 250 g/mol, less than 200 g/mol or less than 150 g/mol.

According to one embodiment, component b) comprises a polyol chosen from ethylene glycol, 1,2-propanediol, 1,3-propanediol, 1,4-butanediol, 1,3-butanediol, 1,5-pentanediol, 1,6-hexanediol, 3-methyl-1,5-pentanediol, 1,10-decanediol, 1,12-dodecanediol, diethylene glycol, triethylene glycol, dipropylene glycol, tripropylene glycol, polyoxyalkylenes such as polyethylene glycol or polypropylene glycol, preferably having a number-average molecular mass Mn (calculated from the OH number) ranging from 250 to 3000, 1,4-cyclohexanedimethanol, 1,6-cyclohexanedimethanol, 1,4-cyclohexanediol, bisphenol A, hydrogenated bisphenol A, glycerol, diglycerol, tricyclodecanedimethanol, trimethylolpropane, di(trimethylolpropane), trimethylolethane, 1,2,6-hexanetriol, 1,2,4-butanetriol, erythritol, pentaerythritol, di(pentaerythritol), neopentyl glycol, 2-butyl-2-ethyl-1,3-propanediol, 2-methyl-1,3-propanediol, 2-methyl-1,2-propanediol, sorbitol, mannitol, xylitol, isosorbide, isoidide, isomannide, methyl glucoside, polyester polyols (in particular polycaprolactone polyol), polycarbonate polyols, polyorganosiloxane polyols (in particular polydimethysiloxane polyol), polyglycerols such as glycerol oligomers such as Polyglycerol-3 (glycerol trimer) and decaglycerol, a hydroxy-terminated polybutadiene, partially or completely alkoxylated, in particular ethoxylated or propoxylated, derivatives of the cited polyols, and mixtures thereof.

According to one particular embodiment, component b) comprises a saturated aliphatic polyol having a functionality of from 2 to 4, more particularly neopentyl glycol, trimethylolpropane, an ethoxylated trimethylolpropane, pentaerythritol, and mixtures thereof.

The amount of component b) used in the preparation of the polyol PE1 may notably range from 1 to 70%, in particular 5 to 50%, more particularly 10 to 40%, by weight relative to the total weight of compounds a1)+a2)+b)+c)+d)+e).

The component c) optionally used to make the polyol PE1 comprises a chain extender comprising a graftable function and an isocyanate-reactive function. Component c) can comprise a plurality of graftable functions and/or a plurality of isocyanate-reactive functions. It is also possible to use a mixture of chain extenders. Component c) is different from components a1), a2), b), d) and e).

The graftable function of compound c) can in particular be chosen from hydroxyl, thiol, amine and carboxylic acid.

The isocyanate-reactive function of compound c) can in particular be chosen from hydroxyl and amine.

Compound c) can in particular be an amino alcohol, an amino thiol, a diamine, a mercapto alcohol, a mercapto acid, a dithiol, and mixtures thereof.

The chain extender can notably be aliphatic, cycloaliphatic or aromatic, in particular aliphatic or cycloaliphatic. The chain extender can in particular comprise 2 to 18 carbon atoms.

According to one particular embodiment, the chain extender comprises a primary or secondary amine function, in particular a secondary amine function, and one or two hydroxyl or thiol functions.

Examples of suitable components c) are ethanolamine, N-methylethanolamine, N-ethylethanolamine, N-propylethanolamine, N-butylethanolamine, diethanolamine, propanolamine, ethylenediamine, 1,3-propylenediamine, 1,4-butylenediamine, 1,5-pentamethylenediamine, 1,6-hexamethylenediamine, 1,4-cyclohexanediamine, bis(aminomethyl)-1,3-cyclohexane (1,3-BAC), bis(aminomethyl)-1,4-cyclohexane (1,4-BAC), bis(aminomethyl)-1,2-cyclohexane (1,2-BAC), isophoronediamine, 1-mercapto-2-propanol, 3-mercapto-1-propanol, thioglycolic acid, 3-mercaptopropionic acid, 2-amino-1-ethanethiol, 3-amino-1-propanethiol, cysteine, 1,2-ethanedithiol, 1,3-propanedithiol, and mixtures thereof.

The amount of component c) used in the preparation of the polyol PE1 may notably range from 0 to 50%, in particular 5 to 40%, more particularly 10 to 35%, by weight relative to the total weight of compounds a1)+a2)+b)+c)+d)+e).

The component d) used to make the polyol PE1 comprises a hydrophilic compound. A hydrophilic compound is a compound comprising a heteroatom. The hydrophilic compound according to the invention comprises an acid group having a pKa of less than 3, optionally in partially or completely neutralized form, and a graftable function. Component d) can comprise a plurality of acid groups and/or a plurality of graftable functions. It is also possible to use a mixture of hydrophilic compounds. Component d) is different from components a1), a2), b), c) and e).

Component d) makes it possible to introduce an ionizable group into the polyol PE1. In this way, the poly(ester-urethane) incorporating this polyol will be capable of self-emulsification.

According to one particular embodiment, the hydrophilic compound comprises an acid group having a pKa of less than 3 chosen from a sulfonylated group (—S(═O)₂OR), a phosphonylated group (—P(═O)(OR)₂), a sulfated group (—O—S(═O)₂OR), a phosphated group (—O—P(═O)(OR)₂), and mixtures thereof, each R independently being a hydrogen atom, a metal salt or a hydrocarbyl chain. The sulfonylated, phosphonylated, sulfated and phosphated groups described above are bonded to a carbon atom. In particular, the hydrophilic compound can comprise an acid group chosen from a sulfonylated group and a phosphonylated group. More particularly, the acid group can be a sulfonylated group of the formula —S(═O)₂OR, with R being a hydrogen atom or a metal salt, in particular an alkali metal salt such as, for example, a sodium, potassium or lithium salt or a divalent salt such as, for example, a calcium, magnesium or aluminum salt.

According to one particular embodiment, the hydrophilic compound comprises one or two, preferably two, graftable functions chosen from —OH, —NH₂ and —COOH, in particular —COOH.

According to one particular embodiment, the acid group of the hydrophilic compound is a sulfonylated group of the formula —S(═O)₂OR with R being a hydrogen atom or a metal salt and the graftable function of the hydrophilic compound is —OH, —NH₂, —COOH or —C(═O)—OR₃ with R₃ being C₁-C₆ alkyl, in particular —COOH or —C(═O)—OR₃.

The hydrophilic compound can in particular be an aliphatic, cycloaliphatic or aromatic, in particular aromatic, compound.

Examples of suitable components d) are sulfoisophthalic acid, sulfoisophthalic acid sodium salt (SSBA), sulfoisophthalic acid lithium salt (LiSIPA), sulfoisophthalic acid potassium salt (KSBA), dimethyl sulfoisophthalate sodium salt, sulfosuccinic acid, meta-sulfobenzoic acid sodium salt, taurine, 2-hydroxy-5-sulfobenzoic acid sodium salt, dimethyl sulfoisophthalate sodium salt, 2-aminoethylphosphonic acid, and mixtures thereof.

The amount of component d) used in the preparation of the polyol PE1 may notably range from 1 to 40%, in particular 2 to 30%, more particularly 5 to 20%, by weight relative to the total weight of compounds a1)+a2)+b)+c)+d)+e).

The optional component e) makes it possible to introduce a saturated fatty chain and/or an unsaturated fatty chain into the polyol PE1. In this way, the poly(ester-urethane) incorporating this polyol will be more easily emulsifiable.

Component e) comprises a graftable function and a saturated fatty chain and/or an unsaturated fatty chain. The graftable function can in particular be chosen from hydroxyl, glycidyl, carboxylic acid, ester and amine. Component e) is different from components a1), a2), b), c) and d).

According to one particular embodiment, component e) can be chosen from:
e1) an unsaturated fatty acid,
e2) a saturated fatty acid,
e3) a fatty alcohol,
e4) an unsaturated fatty amine,

and mixtures thereof.

The component e) used to make the polyol PE1 can comprise an unsaturated fatty acid e1). It is also possible to use a mixture of unsaturated fatty acids e1).

The unsaturated fatty acid e1) can in particular have an average iodine number ranging from 100 to 200 mg I₂/g as measured according to the method described below.

The unsaturated fatty acid can notably correspond to the formula Alc-COOH with Alc being a C₆-C₆₀, in particular C₈-C₅₅, more particularly C₁₀-C₅₀, alkenyl, where the alkenyl may be substituted by one or more hydroxyl groups.

Examples of suitable unsaturated fatty acids e1) are myristoleic acid, palmitoleic acid, sapienic acid, oleic acid, ricinoleic acid (12-hydroxy-9-octadecenoic acid), dehydrated ricinoleic acid, elaidic acid, trans-vaccenic acid, linoleic acid, linolelaidic acid, α-linolenic acid, γ-linolenic acid, dihomo-γ-linolenic acid, arachidonic acid, eicosapentaenoic acid, clupanodonic acid, docosahexaenoic acid, eleostearic acid, licanic acid, erucic acid, brassidic acid, lesquerolic acid (14-hydroxy-11-cis-eicosenoic acid), auricolic acid, densipolic acid, Nouracid® DE656, DE655, DE554, DE503, DZ453 (dehydrated castor fatty acid—Oleon), Nouracid® HE456, HE305, HE304 (isomerized sunflower fatty acid—Oleon), Nouracid® LE805 (isomerized linseed fatty acid—Oleon), Dedico® 5981 (dehydrated castor fatty acid—Croda), Isomergin® SK, SY, SF (isomerized vegetable fatty acid—Hobum Harburger Fettchemie Brinkcman & Mergell GmbH), Pamolyn® 300, 380 (isomerized linoleic acid—Eastman), unsaturated fatty acids obtained from soybean oil, from sunflower oil, from safflower oil, from cottonseed oil, from tall oil (“tall oil fatty acid” (TOFA)), from castor oil, from dehydrated castor oil (“dehydrated castor oil fatty acid” (DCOFA)), from linseed oil, from Chinese wood (tung) oil, from oiticica oil, from rapeseed oil, from corn oil, from calendula oil, from hemp oil, from lesquerella oil, and mixtures thereof.

The unsaturated fatty acid e1) can be an unsaturated fatty acid derivative. Such a derivative can be transformed into unsaturated fatty acid by hydrolysis or transesterification.

Suitable unsaturated fatty acid derivatives are unsaturated fatty acid esters. These compounds can be obtained by reaction between one or more unsaturated fatty acids and an alcohol compound, in particular a monoalcohol (for example methanol, ethanol, propanol, isopropanol, butanol), a diol or a triol (for example glycerol). The unsaturated fatty acid esters obtained with glycerol are commonly called oils or triglycerides.

Stand oils are also fatty acid derivatives in the context of the invention. Said stand oils, well known to those skilled in the art, are in fact the products resulting from the reaction at high temperature, for example 250 to 300° C., of a mixture of oil and fatty acid.

Another example of a suitable unsaturated fatty acid derivative is an estolide. Estolides are obtained in particular by formation of an ester bond between a carboxylic acid (for example a fatty acid) and the hydroxyl function of an unsaturated hydroxylated fatty acid (for example, ricinoleic acid, lesquerellic acid, auricolic acid or densipolic acid) or of a hydroxylated fatty acid derivative (for example castor oil or lesquerella oil).

According to one particular embodiment, component e) comprises an unsaturated fatty acid having a hydrocarbyl chain having 15 to 29 consecutive carbon atoms, more particularly a dehydrated castor oil fatty acid.

The component e) used to make the polyol PE1 can comprise a saturated fatty acid e2). It is also possible to use a mixture of saturated fatty acids e2).

The saturated fatty acid can notably correspond to the formula Alk-COOH with Alk being a C₆-C₆₀, in particular C₈-C₅₅, more particularly C₁₀-C₅₀, alkyl, where the alkyl may be substituted by one or more hydroxyl and/or glycidyl groups.

Examples of suitable saturated fatty acids e2) are caproic acid, caprylic acid, capric acid, lauric acid, myristic acid, palmitic acid, stearic acid, 9-hydroxystearic acid, 10-hydroxystearic acid, 12-hydroxystearic acid, eicosanoic acid, 14-hydroxyeicosanoic acid, saturated fatty acids derived from palm oil, from coconut oil, from hydrogenated castor oil, from animal fats, and mixtures thereof.

The saturated fatty acid can be a saturated fatty acid derivative. Such a derivative can be transformed into saturated fatty acid by hydrolysis or transesterification as described above.

The component e) used to make the polyol PE1 can comprise a fatty alcohol e3). It is also possible to use a mixture of fatty alcohols e3).

The fatty alcohol can notably correspond to the formula Alk-(O—CH₂—CH₂)ₙ—(O—CH(CH₃)—CH₂)ₘ—OH with Alk being a C₆-C₆₀, in particular C₈-C₅₅, more particularly C₁₀-C₅₀, alkyl, and n and m=0 to 50.

Examples of suitable fatty alcohols e3) are octan-1-ol, octan-2-ol, 2-ethyl-1-hexanol, nonan-1-ol, decan-1-ol, undecan-1-ol, lauryl alcohol, myristyl alcohol, cetyl alcohol, stearyl alcohol, docosanol, and the alkoxylated, in particular ethoxylated and/or propoxylated, derivatives of the polyols cited above, and mixtures thereof.

The component e) used to make the polyol PE1 can comprise an unsaturated fatty amine e4). It is also possible to use a mixture of unsaturated fatty amines e4).

The unsaturated fatty amine can notably correspond to the formula Alc-NHR with Alc being a C₆-C₆₀, in particular C₈-C₅₅, more particularly C₁₀-C₅₀, alkenyl, where the alkenyl may be substituted by one or more hydroxyl groups, and R is H or a C₁-C₆ alkyl. Examples of unsaturated fatty amines can notably correspond to the unsaturated fatty acids described above by replacing the carboxylic acid function with an amine function.

The amount of component e) used in the preparation of the polyol PE1 may notably range from 0 to 90%, in particular 5 to 80%, more particularly 10 to 70%, more particularly still 20 to 60%, by weight relative to the total weight of compounds a1)+a2)+b)+c)+d)+e).

According to one particular embodiment, the polyester polyol PE1 is obtained by reacting:
1 to 50%, in particular 5 to 40%, more particularly 10 to 30%, of compound a1);
0 to 50%, in particular 0 to 30%, more particularly 0 to 20%, of compound a2);
1 to 70%, in particular 5 to 50%, more particularly 10 to 40%, of compound b);
0 to 50%, in particular 5 to 40%, more particularly 10 to 35%, of compound c); and
1 to 40%, in particular 2 to 30%, more particularly 5 to 20%, of compound d);
0 to 90%, in particular 5 to 80%, more particularly 20 to 60%, of compound e);

the percentages being percentages by weight expressed relative to the weight of all of the compounds a1)+a2)+b)+c)+d)+e).

According to one embodiment, the weight of all of the compounds a1)+a2)+b)+c)+d)+e) represents 100% of the weight of the polyol PE1.

The polyol P1 can also be an elongated polyol produced by reaction between the polyester polyol PE1 as described above and a polyisocyanate having a deficit of NCO functions. This reaction corresponds to a chain elongation by formation of urethane bonds. The elongation reaction is notably controlled so as to obtain an NCO number of less than 20 mg KOH/g, in particular less than 10 mg KOH/g, more particularly less than 1 mg KOH/g. The resulting elongated polyol comprises in particular hydroxyl functions, ester bonds and urethane bonds. The elongated polyol can optionally comprise an amide and/or urea bond. If the polyol PE1 comprises an amine function, the elongated polyol will comprise a urea bond.

The polyol P2 comprises an acid group having a pKa of less than 3, but does not comprise a saturated fatty chain or an unsaturated fatty chain.

The polyol P2 can in particular be a polyester polyol PE2 obtained by polycondensation of the following components:
a) an acid component comprising:
   a1) a compound chosen from a polyacid having a carboxylic acid functionality of from 2 to 3, a cyclic anhydride, and mixtures thereof; and
   a2) optionally a C₂-C₁₀ monoacid;
b) a polyol component comprising a polyol having a functionality ranging from 2 to 6;
c) optionally a chain extender comprising a graftable function and an isocyanate-reactive function; and
d) a hydrophilic compound comprising an acid group having a pKa of less than 3, optionally in partially or completely neutralized form, and a graftable function.

The polycondensation can be carried out by reacting the various components in a single step or in successive steps. For example component b) and component d) can be reacted in a first step and then this intermediate can be reacted with the component a1) in a second step. Of course, the sequence in which the various reactants are introduced can be varied.

The polycondensation can be carried out in the absence of solvent other than water, in particular in the absence of acetone and xylene. Thus, the reaction medium can in particular contain less than 10%, in particular less than 5%, more particularly less than 1%, more particularly still less than 0.1%, by weight of solvent other than water, in particular acetone and xylene. More particularly, the reaction medium does not comprise any solvent other than the solvent that may be produced during the polycondensation.

The reaction medium can in particular be heated. For example, the temperature of the reaction medium may range from 80 to 250° C., in particular 100 to 220° C., more particularly from 120 to 200° C.

According to one particular embodiment, the water produced during the polycondensation is distilled as it is formed.

The progress of the polycondensation can be monitored via the acid number of the reaction mixture.

Components a1), a2), b), c) and d) can be as defined above for the polyester polyol PE1.

According to one particular embodiment, the polyester polyol PE2 is obtained by reacting:
10 to 70%, in particular 15 to 60%, more particularly 20 to 50%, of compound a1);
0 to 50%, in particular 0 to 30%, more particularly 0 to 20%, of compound a2);
10 to 90%, in particular 15 to 70%, more particularly 20 to 50%, of compound b);
0 to 50%, in particular 0 to 30%, more particularly 0 to 20%, of compound c); and
1 to 50%, in particular 5 to 40%, more particularly 10 to 30%, of compound d);

the percentages being percentages by weight expressed relative to the weight of all of the compounds a1)+a2)+b)+c)+d).

According to one embodiment, the weight of all of the compounds a1)+a2)+b)+c)+d) represents 100% of the weight of the polyol PE2.

The polyol P2 can also be an elongated polyol produced by reaction between the polyester polyol PE2 and a polyisocyanate with a deficit of NCO functions, as described for polyol P1.

The polyol P3 optionally comprises a saturated fatty chain and/or an unsaturated fatty chain, but does not comprise an acid group having a pKa of less than 3.

According to one embodiment, the polyol P3 can be a polyester polyol PE3-1 obtained by polycondensation of the following components:
a) an acid component comprising:
   a1) a compound chosen from a polyacid having a carboxylic acid functionality of from 2 to 3, a cyclic anhydride, and mixtures thereof; and
   a2) optionally a C₂-C₁₀ monoacid;
b) a polyol component comprising a polyol having a functionality ranging from 2 to 6;
c) optionally a chain extender comprising an amine function and one or two functions chosen from amine, hydroxyl, and mixtures thereof; and
e) optionally a fatty component comprising a graftable function and a saturated fatty chain and/or an unsaturated fatty chain.

According to another embodiment, the polyol P3 can be a polyester polyol PE3-2 obtained by polycondensation of the following components:
a) optionally an acid component comprising:
   a1) a compound chosen from a polyacid having a carboxylic acid functionality of from 2 to 3, a cyclic anhydride, and mixtures thereof; and
   a2) optionally a C₂-C₁₀ monoacid;
b) optionally a polyol component comprising a polyol having a functionality ranging from 2 to 6;
c) optionally a chain extender comprising an amine function and one or two functions chosen from amine, hydroxyl, and mixtures thereof; and
e) a fatty component comprising a graftable function and a saturated fatty chain and/or an unsaturated fatty chain;

with the proviso that at least one from among the acid component a) and the polyol component b) is present and can react with the graftable function of the fatty component to form an ester bond.

The polycondensation can be carried out between the components a) and e), optionally in the presence of b) and/or c). Alternatively, the polycondensation can be carried out between the components b) and e), optionally in the presence of a) and/or c).

According to one embodiment, the fatty component comprises a graftable hydroxyl or glycidyl function and the polyacid component a) is present. In this case, the polyol component b) is not necessary, but it can optionally be present.

According to another embodiment, the fatty component comprises a graftable carboxylic acid or ester function and the polyol compound b) is present. In this case, the polyacid component a) is not necessary, but it can optionally be present.

The polycondensation can be carried out by reacting the various components in a single step or in successive steps.

The polycondensation can be carried out in the absence of solvent other than water, in particular in the absence of acetone and xylene. Thus, the reaction medium can in particular contain less than 10%, in particular less than 5%, more particularly less than 1%, more particularly still less than 0.1%, by weight of solvent other than water, in particular acetone and xylene. More particularly, the reaction medium does not comprise any solvent other than the solvent that may be produced during the polycondensation.

The reaction medium can in particular be heated. For example, the temperature of the reaction medium may range from 100 to 300° C., in particular 150 to 270° C., more particularly from 200 to 250° C.

According to one particular embodiment, the water produced during the polycondensation is distilled as it is formed.

The progress of the polycondensation can be monitored via the acid number of the reaction mixture.

Components a1), a2), b), c) and e) are as defined above for the polyester polyol PE1.

According to one particular embodiment, the polyester polyol PE3-1 is obtained by reacting:
10 to 70%, in particular 15 to 60%, more particularly 20 to 50%, of compound a1);
0 to 50%, in particular 0 to 40%, more particularly 0 to 35%, of compound a2);
10 to 90%, in particular 15 to 70%, more particularly 20 to 50%, of compound b); and
0 to 50%, in particular 0 to 30%, more particularly 0 to 20%, of compound c); and
0 to 90%, in particular 0 to 70%, more particularly 0 to 60%, of compound e);

the percentages being percentages by weight expressed relative to the weight of all of the compounds a1)+a2)+b)+c)+e).

According to one particular embodiment, the polyester polyol PE3-2 is obtained by reacting:
0 to 70%, in particular 15 to 60%, more particularly 20 to 50%, of compound a1);
0 to 50%, in particular 0 to 40%, more particularly 0 to 35%, of compound a2);
0 to 90%, in particular 15 to 70%, more particularly 20 to 50%, of compound b); and
0 to 50%, in particular 0 to 30%, more particularly 0 to 20%, of compound c); and
5 to 90%, in particular 10 to 70%, more particularly 20 to 60%, of compound e);

the percentages being percentages by weight expressed relative to the weight of all of the compounds a1)+a2)+b)+c)+e).

According to one embodiment, the weight of all of the compounds a1)+a2)+b)+c)+e) represents 100% of the weight of the polyol PE3.

The polyol P3 can also be an elongated polyol produced by reaction between the polyester polyol PE3 and a polyisocyanate with a deficit of NCO functions, as described for polyol P1.

The polyol P4 that can be used during the preparation of the poly(ester-urethane) can in particular make it possible to compatibilize the polyisocyanate with the polyols P1, P2 and/or P3 The polyol P4 can in particular be as defined above for the polyol component b).

According to one particular embodiment, polyol P4 comprises an aliphatic polyol, more particularly neopentyl glycol, trimethylolpropane, pentaerythritol, glycerol, alkoxylated, in particular ethoxylated and/or propoxylated, derivatives of the polyols cited above, and mixtures thereof.

The fatty component CG that can be used during the preparation of the poly(ester-urethane) in particular makes it possible to facilitate the later emulsification of the poly(ester-urea-urethane) particles that will be obtained with the poly(ester-urethane). The fatty component CG can be as defined for the fatty component e) that can be used in the preparation of the polyol PE1.

According to one embodiment, the fatty component CG is a fatty alcohol e3) as defined above.

The poly(ester-urethane) obtained by the process described above can be elongated to form a poly(ester-urea-urethane).

Poly(Ester-Urea-Urethane)

The poly(ester-urea-urethane) according to the invention comprises:
acid groups having a pKa of less than 3, optionally in partially or completely neutralized form;
optionally saturated fatty chains and/or unsaturated fatty chains; and
ester, urea and urethane bonds.

The poly(ester-urea-urethane) according to the invention can in particular correspond to a mixture of poly(ester-urea-urethanes) or to a distribution of poly(ester-urea-urethanes) having a different number of acid groups having a pKa of less than 3, ester bonds, urea bonds and urethane bonds.

According to one particular embodiment, the poly(ester-urea-urethane) may additionally comprise an amide bond.

The poly(ester-urea-urethane) according to the invention can comprise a small number of hydroxyl functions. The content of hydroxyl functions in the poly(ester-urea-urethane) can in particular be estimated by the OH number. According to one embodiment, the poly(ester-urea-urethane) can have an OH number of less than 120 mg KOH/g, in particular of less than 60 mg KOH/g, more particularly of less than 40 mg KOH/g, more particularly still of less than 20 mg KOH/g, even more particularly still of less than 10 mg/KOH/g. The OH number can in particular be measured according to the method described below.

According to one particular embodiment, the poly(ester-urea-urethane) according to the invention does not comprise any amine functions. The content of amine functions in the poly(ester-urea-urethane) can in particular be estimated by the amine number. According to one embodiment, the poly(ester-urea-urethane) can have an amine number of less than 20 mg KOH/g, in particular of less than 10 mg KOH/g, more particularly of less than 1 mg KOH/g, more particularly still of less than 0.1 mg KOH/g. The amine number can in particular be measured according to the method described below.

The poly(ester-urea-urethane) according to the invention can comprise saturated fatty chains and/or unsaturated fatty chains. According to one particular embodiment, the poly(ester-urea-urethane) can have a content of saturated fatty chains and/or unsaturated fatty chains of 0%. It is then said that the poly(ester-urea-urethane) has zero oil content (oil-free polyester). According to another particular embodiment, the poly(ester-urea-urethane) can have a content of saturated fatty chains and/or unsaturated fatty chains of at least 5%, in particular from 10 to 60%, more particularly from 15 to 40%, relative to the total weight of the poly(ester-urea-urethane). The content of saturated fatty chains and/or unsaturated fatty chains can in particular be calculated according to the method described below. It is then said that the poly(ester-urea-urethane) is an alkyd-urea-urethane.

The poly(ester-urea-urethane) according to the invention comprises acid groups having a pKa of less than 3, optionally in partially or completely neutralized form. The acid groups having a pKa of less than 3 may in particular make it possible to achieve an aqueous phase self-emulsification of the poly(ester-urea-urethane). The choice of a pKa of less than 3 for the acid group excludes carboxylic acid and carboxylate groups. The acid groups having a pKa of less than 3 can in particular be as described above for the poly(ester-urethane).

The poly(ester-urea-urethane) can optionally be in crosslinked form. The crosslinking of the poly(ester-urea-urethane) can be characterized by dynamic mechanical analysis (DMA), as defined below. The crosslinking can be present within the particles that will be obtained after emulsification of the poly(ester-urea-urethane). Thus, the particles can be pre-crosslinked before the coalescence that leads to the formation of a film.

The poly(ester-urea-urethane) can notably comprise less than 10%, in particular less than 5%, more particularly less than 1%, more particularly still less than 0.1%, by weight of solvent other than water.

The poly(ester-urea-urethane) can notably comprise less than 10%, in particular less than 5%, more particularly less than 1%, more particularly still less than 0.1%, by weight of volatile amine, such as triethylamine.

The poly(ester-urea-urethane) can notably comprise less than 2%, in particular less than 1%, more particularly less than 0.01%, by weight of metal-based urethanization catalyst. Examples of urethanization catalysts are organometallic compounds, in particular based on tin, on cadmium, on zirconium, on zinc, on titanium or on bismuth, such as in particular dibutyltin dilaurate, dibutyltin oxide or bismuth neodecanoate.

The poly(ester-urea-urethane) can in particular be obtained by the process described below.

Process for Preparing the Poly(Ester-Urea-Urethane)

The poly(ester-urea-urethane) according to the invention can be obtained by elongation reaction of the poly(ester-urethane) as defined above in water. This elongation reaction can in particular correspond to the formation of urea bonds on the isocyanate functions of the poly(ester-urethane).

The elongation reaction can be carried out in the presence of a polyamine component having a functionality ranging from 2 to 6, in particular from 2.25 to 6, more particularly from 2.5 to 6, more particularly still from 3 to 6, the molar ratio between the amine functions of the optional polyamine component and the isocyanate functions of the poly(ester-urethane) being from 0.01 to 3, in particular from 0.2 to 1.5, more particularly from 0.5 to 1.

The polyamine component comprises a polyamine. The polyamine component may comprise a mixture of polyamines. When the polyamine component comprises a single polyamine, the functionality of the polyamine component corresponds to the functionality of the polyamine. When the polyamine component comprises a mixture of polyamines, the functionality of the polyamine component corresponds to the number-average functionality of amine functions in the polyamines used in the mixture.

According to one particular embodiment, the elongation reaction is carried out in the presence of a polyamine component having a functionality of from 2.25 to 6, in particular from 2.5 to 6, more particularly from 3 to 6. The poly(ester-urea-urethane) obtained under these conditions is advantageously in crosslinked form.

Alternatively, the elongation reaction can be performed in water, without adding an additional reactant. This is because a portion of the isocyanate functions of the poly(ester-urethane) can react with water to form primary amine functions which can then react with the residual isocyanate functions of the poly(ester-urethane) and form urea bonds.

The elongation reaction can notably be carried out at a temperature of from 10 to 100° C., in particular from 20 to 80° C., and more particularly from 30 to 70° C.

Before the elongation reaction, partial or complete neutralization of the acid groups of the poly(ester-urethane) can optionally be carried out. This partial or complete neutralization can in particular be carried out by adding a base to the poly(ester-urethane). If the acid groups of the poly(ester-urethane) are already in partially or completely neutralized form, the neutralization step is not necessary. According to one particular embodiment, the base used for the neutralization is chosen from a tertiary amine, a metal hydroxide, an alkoxide and a quaternary ammonium, in particular an alkali metal hydroxide, more particularly KOH, LiOH and NaOH.

According to one particular embodiment, the poly(ester-urethane) is dispersed in water. The dispersion can in particular be carried out by gradual addition of water to the poly(ester-urethane) and phase inversion or by addition of the poly(ester-urethane) to water.

Once the poly(ester-urethane) has been dispersed in the water, the polyamine component can optionally be added. The polyamine component can be added neat or diluted in water.

The polyamine component that can be used in the elongation reaction can notably comprise an aliphatic, cycloaliphatic or aromatic, in particular aliphatic, polyamine.

According to one embodiment, the polyamine component comprises a polyalkyleneamine, in particular a polyethyleneamine. A polyalkyleneamine is a polyamine in which the amine functions are bonded to one another via an alkylene bridge, in particular an ethylene bridge. A polyalkyleneamine can in particular be aliphatic or cycloaliphatic, in particular aliphatic.

An aliphatic polyalkyleneamine can in particular be represented by the following formula (I):

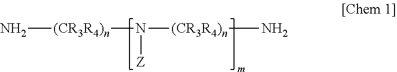

with n=2 to 6, in particular n=2;

m=0 to 6;

each R₃ is independently H or C₁-C₆ alkyl, in particular H or methyl, more particularly H;

each R₄ is independently H or C₁-C₆ alkyl, in particular H or methyl, more particularly H;

each Z is independently H or —(CR₃R₄)ₙ—NH₂, in particular Z is H.

According to one particular embodiment, the aliphatic polyalkyleneamine is represented by the formula (I) above, in which n=2, more particularly n=2 and Z is H.

Examples of aliphatic polyalkyleneamines are ethylenediamine, diethylenetriamine, triethylenetetramine, tetraethylenepentamine, 3,3,5-trimethyl-1,6-hexanediamine, 3,5,5-trimethyl-1,6-hexanediamine, 2-methyl-1,5-pentanediamine, N,N′-bis(3-aminopropyl)-1,2-ethanediamine and N-(3-aminopropyl)-1,2-ethanediamine.

The use of a polyalkyleneamine having a functionality of greater than 2, in particular of greater than 3, or of a mixture of polyalkyleneamines having an average functionality of from 2.25 to 6, in particular from 2.5 to 6, advantageously makes it possible to obtain particles of poly(ester-urea-urethane) in crosslinked form.

It is also possible to use cycloaliphatic polyalkyleneamines comprising a piperazine unit. A cycloaliphatic polyalkyleneamine comprising a piperazine unit can in particular be represented by the following formula (II):

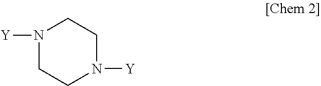

in which each Y is independently H or —(CR₃R₄)ₙ—[N(Z)—(CR₃R₄)ₙ]ₘ—NH₂;

m, n, R₃, R₄ and Z being as defined above for formula (I).

According to one particular embodiment, the cycloaliphatic polyalkyleneamine is represented by the formula (II) above, in which n=2, more particularly n=2 and Z is H.

Examples of cycloaliphatic polyalkyleneamines are piperazine, N-aminoethylpiperazine and N,N′-bis(2-aminoethyl)piperazine.

It is also possible to use cycloaliphatic polyalkyleneamines comprising a cyclohexyl unit. Examples of cycloaliphatic polyalkyleneamines comprising a cyclohexyl unit are 1,2-diaminocyclohexane, 1,3-diaminocyclohexane, 1,4-diaminocyclohexane, isophoronediamine, 3,3′-dimethyl-4,4′-diaminodicyclohexylmethane, 4,4′-diaminodicyclohexylmethane and 2,4′-diaminodicyclohexylmethane.

According to another embodiment, the polyamine component comprises a polyetheramine. A polyetheramine is a polyamine comprising ether (—O—) bonds, more particularly ethylene oxide (—O—CH₂—CH₂) and/or propylene oxide (—O—CH₂—CHCH₃—) units.

Examples of polyetheramines are the compounds sold by Huntsman under the Jeffamine® reference, in particular the Jeffamine® D, ED and EDR series (diamines) and/or the Jeffamine® T series (triamines). These series include in particular the following references: Jeffamine® D-230, Jeffamine® D-400, Jeffamine® D-2000, Jeffamine® D-4000, Jeffamine® ED-600, Jeffamine® ED-900, Jeffamine® ED-2003, Jeffamine® EDR-148, Jeffamine® EDR-176, Jeffamine® T-403, Jeffamine® T-3000 and Jeffamine® T-5000.

According to another embodiment, the polyamine component comprises an epoxy-amine adduct. An epoxy-amine adduct can in particular be obtained by reacting an excess of polyamine with an epoxy compound. The polyamine can be as described above. The epoxy compound can in particular be a compound comprising a plurality of epoxy functions, such as in particular bisphenol A diglycidyl ether, ethylene glycol diglycidyl ether, butanediol diglycidyl ether and trimethylpropanol triglycidyl ether.

Aqueous Dispersion

The aqueous dispersion according to the invention comprises the poly(ester-urethane) as defined above or the poly(ester-urea-urethane) as defined above.

The acid groups of the poly(ester-urethane) or of the poly(ester-urea-urethane) are in partially or completely neutralized form.

The aqueous dispersion of the invention can in particular comprise polymer particles, in particular poly(ester-urethane) or poly(ester-urea-urethane) particles, dispersed in an aqueous phase.

The aqueous phase is a liquid comprising water. This liquid can also comprise a solvent other than water, such as for example ethanol or isopropanol. Preferably, the aqueous phase comprises less than 10%, in particular less than 5%, more particularly less than 1%, more particularly still less than 0.1%, by weight of solvent other than water, in particular acetone and xylene.

The organic phase can be a polymer phase comprising the poly(ester-urethane) or the poly(ester-urea-urethane) as defined above. A dispersion having a liquid organic phase can correspond to an emulsion. A dispersion having a solid or semisolid organic phase can correspond to a colloidal suspension. In the field of polymers, such colloidal suspensions can also be considered to be emulsions and their preparation process is known under the name emulsion polymerization. Another term frequently used to characterize an aqueous dispersion of polymer particles is “latex”.

According to one embodiment, the aqueous dispersion comprises less than 10%, in particular less than 5%, more particularly less than 1%, more particularly still less than 0.1%, by weight of solvent other than water.

The acid groups having a pKa of less than 3 that are present on the poly(ester-urethane) or the poly(ester-urea-urethane) may suffice to achieve aqueous phase self-emulsification of the poly(ester-urethane) or poly(ester-urea-urethane). According to one embodiment, the aqueous dispersion comprises less than 10%, in particular less than 5%, more particularly less than 1%, more particularly still less than 0.1%, by weight of additional surfactant.

The aqueous dispersion can notably comprise less than 2%, in particular less than 1%, more particularly less than 0.01%, by weight of metal-based urethanization catalyst as defined above.

According to one embodiment, the aqueous dispersion has a solids content of from 5 to 70%, in particular from 10 to 60%, more particularly from 30 to 50%, by weight.

The aqueous dispersion can in particular have a pH of from 5 to 9, in particular from 6 to 8, more particularly from 6.5 to 7.5.

The viscosity of the aqueous dispersion can in particular range from 1 to 10 000 mPa·s, in particular 50 to 2000 mPa·s, more particularly 100 to 1000 mPa·s. The viscosity can be measured at 25° C. according to the measurement method described below.

The polymer particles can notably have an average size of from 10 to 1000 nm, in particular from 40 to 300 nm, more particularly from 50 to 200 nm. The average size of the particles can be measured according to the method described below.

According to one embodiment, the aqueous dispersion comprises particles of poly(ester-urea-urethane) in crosslinked form. The crosslinking of the poly(ester-urea-urethane) can be characterized by dynamic mechanical analysis (DMA), as defined below.

The aqueous dispersion according to the invention can in particular be obtained by the process described below.

Process for Preparing the Aqueous Dispersion

The process for preparing an aqueous dispersion according to the invention can in particular comprise the following steps:
preparing at least one polyol P1 or preparing at least one polyol P2 and at least one polyol P3 as defined above;
preparing a poly(ester-urethane) by polyaddition of at least one polyisocyanate, at least one polyol P1 and optionally another polyol P4 and/or a fatty component CG or by polyaddition of at least one polyisocyanate, at least one polyol P2, at least one polyol P3 and optionally another polyol P4 and/or a fatty component CG, the polyaddition being effected with a molar ratio of the functions NCO/(OH+optional amine) of greater than 1, in particular from 1.1 to 3, more particularly from 1.5 to 2;
optionally partially or completely neutralizing the acid groups of the poly(ester-urethane) by addition of a base;
dispersing the poly(ester-urethane) in water; and
optionally conducting an elongation reaction of the poly(ester-urethane), optionally in the presence of a polyamine component having a functionality ranging from 2 to 6, in particular from 2.25 to 6, more particularly from 2.5 to 6, more particularly still from 3 to 6, the molar ratio between the amine functions of the optional polyamine component and the isocyanate functions of the poly(ester-urethane) being from 0.01 to 3, in particular from 0.2 to 1.5, more particularly from 0.5 to 1.

The step of preparing the polyol P1 or the step of preparing the polyol P2 and the polyol P3 can in particular be as defined above in the process for preparing the poly(ester-urethane). The polyol P1 or the polyols P2 and P3 obtained in this step are used directly in the following step of preparing a poly(ester-urethane).

The step of polyaddition of the polyisocyanate, of the polyol P1 and optionally of another polyol P4 and/or of a fatty component CG, or the step of polyaddition of the polyisocyanate, of the polyol P2, of the polyol P3 and optionally of another polyol P4 and/or of a fatty component CG, can in particular be as defined above in the process for preparing the poly(ester-urethane).

The optional neutralization step can in particular be as defined above in the process for preparing the poly(ester-urea-urethane).

The step of dispersing the poly(ester-urethane) in water can in particular be as defined above in the process for preparing the poly(ester-urea-urethane).

The optional elongation reaction can in particular be as defined above in the process for preparing the poly(ester-urea-urethane).

Coating, Adhesive or Sealant Composition

The coating, adhesive or sealant composition according to the invention comprises a poly(ester-urethane) and/or a poly(ester-urea-urethane) and/or an aqueous dispersion as defined above.

The coating, adhesive or sealant composition is preferably an aqueous composition.

The poly(ester-urethane), the poly(ester-urea-urethane) and/or the aqueous dispersion can in particular play the role of binder in the composition.

The composition can also comprise another aqueous polymer dispersion other than the aqueous dispersion according to the invention.

The other aqueous dispersion can be based on resins and/or polymers and/or copolymers of Mw <200 000 g/mol, preferably chosen from alkyd resins that are unmodified or modified or treated with an oxidizing treatment, such as those described in the patent application WO 2004/069933, acrylic polymers or copolymers (including styrene-acrylic or styrene-maleic anhydride), hydrocarbon resins, rosin resins, polyurethanes, polyurethanes/acrylics, saturated or unsaturated polyesters, polyfunctional (meth)acrylic oligomers, such as epoxy acrylates, urethane acrylates and acrylated acrylates. These resins and/or polymers or copolymers can be dispersed with the aid of surfactants or with the aid of hydrophilic groups in their structure, rendering them self-dispersible.

The composition can also comprise an additional compound chosen from a rheological agent, a thickener, a dispersing and/or stabilizing agent (surfactant, emulsifier), a wetting agent, a filler, a fungicide, a bactericide, a plasticizer, an antifreeze agent, a wax, a dye, a pigment, a leveling agent, a UV absorber, an antioxidant, a solvent, an adhesion promoter, and mixtures thereof.

According to one embodiment, the composition comprises a siccative agent. Siccative agents are typically metal salts, in particular cadmium, tin, cobalt, manganese, zirconium, lead, iron and calcium salts, and organic compounds such as for example fatty acids. According to another embodiment, the composition does not comprise a siccative agent and simply dries with oxygen in the air. The siccative agent makes it possible to increase the polymerization rate of film-forming compositions comprising ethylenically unsaturated bonds. When the polymer particles are in crosslinked form in the aqueous dispersion, it suffices for the aqueous phase to be removed naturally by drying to obtain a coating having good mechanical properties. In this case, the use of a siccative agent is not necessary.

According to one embodiment, the composition according to the invention can be a two-component composition comprising:
Component 1: a poly(ester-urethane) and/or a poly(ester-urea-urethane) and/or an aqueous dispersion according to the invention; and
Component 2: a crosslinking agent chosen from melamine, a polyisocyanate (in particular a blocked polyisocyanate), a polyanhydride or a polysilane (in particular an alkoxy-blocked polysilane).

A crosslinking agent can in particular be used when the poly(ester-urethane) or the poly(ester-urea-urethane) has an oil length of zero (oil-free polyester) and has primary or secondary amine functions.

The composition according to the invention can be applied to a wide variety of substrates, including wood, metal, stone, plaster, concrete, glass, fabric, leather, paper, a plastic, a composite. The application can be carried out in a conventional manner, in particular with a brush or a roller, by spraying, immersion or covering.

The composition can in particular be used to obtain a film, a varnish, a lacquer, a stain composition, an adhesion primer, a paint, an ink, an adhesive or a sealant.

After the composition has been applied, the aqueous phase can be removed naturally by drying in the open air, in particular at ambient temperature or with heating.

Thus, the invention also relates to a coating, an adhesive or a sealant obtained by application and drying of the composition according to the invention.

Use as Binder

The invention also relates to the use of a poly(ester-urethane) and/or a poly(ester-urea-urethane) and/or an aqueous dispersion as defined above as binder, in particular as binder in a coating, adhesive or sealant composition. More particularly, this use relates to decorative or industrial aqueous coatings, adhesives or sealants selected from films, varnishes, lacquers, stain compositions, adhesion primers, paints, inks, adhesives or sealants,

These coatings are suitable for substrates selected from wood, metal, stone, plaster, concrete, glass, fabric, leather, paper, a plastic, a composite.

The invention is illustrated by the following non-limiting examples.

### EXAMPLES

Measurement Methods

The measurement methods used in the present patent application are described below:

NCO Number

The NCO number (I_{NCO} expressed in mg KOH per gram of product) is measured by quantitative determination with a Metrohm (848 Titrino Plus) titrimeter equipped with a Metrohm reference 6.0229.100 measurement probe. The sample to be analyzed is weighed into a 250 ml screw-necked Erlenmeyer flask. 50 ml of acetone are added and the Erlenmeyer flask is hermetically closed. The sample is completely dissolved by magnetic stirring, if necessary while heating. If the dissolution of the sample has required heating, the mixture is left to return to ambient temperature before the following operation. 15 ml of 0.15N dibutylamine in toluene are added using a 15 ml precision pipette. The Erlenmeyer flask is hermetically stoppered and reaction is allowed to take place under gentle stirring for 15 minutes. 100 ml of isopropanol are added while taking care to rinse the walls of the Erlenmeyer flask. Titration is carried out under magnetic stirring with 0.1N aqueous hydrochloric acid, according to the method of use of the chosen titrimeter. A blank quantitative determination (without sample) is carried out under the same conditions. The NCO number is calculated according to the following equation:

$${I}_{NCO} ( mg KOH / g ) = \frac{( VB - VS ) \times NT \times 56.1}{W}$$

with

VS=Volume of titrant added for the quantitative determination of the sample (ml)

VB=Volume of titrant added for the quantitative determination of the blank (ml)

NT=Normality of the titrant (0.1N)

W=Weight of the sample (g).

OH Number

The OH number is measured according to the standard ISO 2554 (October 1998).

Acid Number

The acid number is measured according to the standard ISO 2114 (November 2000).

Amine Number

The amine number (I_{AM} expressed in mg KOH per gram of product) is measured by direct acid-base titration under the following conditions: an exact weight w of product (exactly 1 gram) is dissolved in approximately 40 ml of glacial acetic acid. The basicity is titrated with a solution of perchloric acid in glacial acetic acid having an exact normal titer N (in Eq/l) of approximately 0.1N. The equivalent point is detected using a glass electrode (filled with a solution of lithium perchlorate at 1 mol per liter in glacial acetic acid) servo-controlling an automatic burette (716 DMS Titrino® Metrohm automatic titration device) delivering the equivalent volume VE. The amine number (I_{AM}) is calculated using the following formula:

$${I}_{AM} ( mg KOH / g ) = \frac{VE \times N \times 56.1}{w}$$

with

VE=Equivalent volume (ml)

N=Normality of the titrant (Eq/l)

w=Weight of the sample (g).

Fatty Chain Content

The fatty chain content corresponds to the percentage by weight of fatty component (saturated fatty acid, unsaturated fatty acid, fatty alcohol) relative to the weight of all of the constituents used in the preparation of the poly(ester-urethane) or of the poly(ester-urea-urethane).

Average Iodine Number

The average iodine number is measured according to the standard ISO 3961 (August 2018).

Crosslinking/DMA

The presence of crosslinking can be demonstrated by dynamic mechanical analysis (DMA). This technique makes it possible to record the storage modulus (G′) and loss modulus (G″) of a material as a function of the temperature. The ratio G″/G′ is also defined as the loss factor or tangent delta (tan delta) of a material. The glass transition of a material corresponds to the temperature for which the value of this tangent is at its maximum (Tα).

A sample is crosslinked when the storage modulus G′ exhibits a plateau after the glass transition. On the other hand, in this case the loss factor (tan delta) tends towards zero.

The measurements of the storage modulus (G′) and loss modulus (G″) were carried out on a Rheometric Scientific RSA II instrument operated using the RSI Orchestrator software, with a temperature rise of from −50° C. to 200° C., with stationary phases of 3° C. and 20 seconds of stabilization per stationary phase, by subjecting a sample in the form of a film of a thickness of around 20 microns and dimensions of 7×6 mm (useful length between adjustable jaws of between 5 and 6 mm, these sample form values being taken into account in the calculation of the moduli by the software) at a sinusoidal tensile stress in force tracking mode of 110% with an initial static force of 2 g, a deformation rate of 0.05% and a frequency of 1 Hz.

Viscosity

The viscosity is measured at 25° C. with a Brookfield viscometer (DV-II+) equipped with an S34 cylindrical spindle rotating at 1 rpm. The temperature is kept constant with a water-circulation temperature regulation system.

Mean Particle Size

The mean particle size is measured by laser particle size analysis on an LS230 instrument (Beckman Coulter). The sample is pre-diluted in demineralized water with magnetic stirring, and then introduced into the particle size analysis tank at the optimal concentration for the measurement (related to the obscuration of the laser beam). The optical model used is: n=1.55-0.1i. The mean particle size corresponds to the diameter D₄₃ which is the volume-average diameter (De Brouckere mean diameter).

Persoz Hardness

The Persoz hardness is measured according to the standard ISO 1522 (March 2007).

Materials

The materials used in the examples are described below:
neopentyl glycol from Perstorp
trimethylolpropane from Perstorp
sulfoisophthalic acid lithium salt from Sigma-Aldrich
sulfoisophthalic acid sodium salt from Sigma-Aldrich
sulfosuccinic acid in the form of a 70% by weight solution in water from Sigma-Aldrich
meta-sulfobenzoic acid sodium salt from Sigma-Aldrich
dimethyl sulfoisophthalate sodium salt from TCI
adipic acid from Bayer
sebacic acid from Sigma-Aldrich
diethyl malonate from Sigma-Aldrich
dehydrated castor fatty acid sold under the reference Nouracid® DE554 by Oléon
BuSnOOH sold under the reference Fascat® 4100 by PMC organometallix

### Example 1: Preparation of a Polyester Polyol PE2(a)

Neopentyl glycol (283.82 g) was heated to 165° C. in a reactor equipped with a distillation column and an inclined-blade stirrer. Sulfoisophthalic acid lithium salt was introduced (177.98 g). The temperature was maintained between 165° C. and 175° C. The water formed in the reaction was distilled until an acid number of less than 10 mg KOH/g was obtained. Adipic acid (200.40 g) was then introduced and the reaction medium was maintained between 175° C. and 185° C. The water formed in the reaction was distilled until an acid number of less than 12 mg KOH/g was obtained.

### Example 2: Preparation of a Polyester Polyol PE2(b)

Neopentyl glycol (141.91 g) was heated to 165° C. in a reactor equipped with a distillation column and an inclined-blade stirrer. Sulfoisophthalic acid sodium salt was introduced (70.00 g). The temperature was maintained between 165° C. and 175° C. The water formed in the reaction was distilled until an acid number of less than 10 mg KOH/g was obtained. Adipic acid (114.42 g) was then introduced and the reaction medium was maintained between 175° C. and 185° C. The water formed in the reaction was distilled until an acid number of less than 12 mg KOH/g was obtained.

### Example 3: Preparation of a Polyester Polyol PE2(c)

Neopentyl glycol (283.82 g) was heated to 165° C. in a reactor equipped with a distillation column and an inclined-blade stirrer. Sulfoisophthalic acid lithium salt was introduced (177.98 g). The temperature was maintained between 165° C. and 170° C. The water formed in the reaction was distilled until an acid number of less than 10 mg KOH/g was obtained. Sebacic acid (262.74 g) was then introduced and the reaction medium was maintained between 175° C. and 185° C. The water formed in the reaction was distilled until an acid number of less than 12 mg KOH/g was obtained.

### Example 4: Preparation of a Polyester Polyol PE2(d)

Neopentyl glycol (141.91 g) and sulfosuccinic acid (99.93 g) were introduced into a reactor equipped with a distillation column and an inclined-blade stirrer. An aqueous 9.681 mol/kg sodium hydroxide solution (36.12 g) was added within 20 minutes at a constant flow rate (1.806 g/min). The mixture was heated at 130° C. for 1 hour in order to distill a first portion of the water. The reactor is then placed under vacuum (0.4 bar). The water formed in the reaction was distilled until an acid number of less than 20 mg KOH/g was obtained. Adipic acid (101.83 g) was introduced and the temperature was maintained between 135° C. and 145° C. The water formed was distilled under vacuum (0.4 bar) until an acid number of less than 12 mg KOH/g was obtained.

### Example 5: Preparation of a Polyester Polyol PE1(a)

Trimethylolpropane (70.0 g) was heated to 150° C. in a reactor equipped with a distillation column and an inclined-blade stirrer. Meta-sulfobenzoic acid sodium salt (40.0 g) was introduced. The reaction medium was heated to 205° C. and the water formed in the reaction was distilled until an acid number of less than 10 mg KOH/g was obtained. Adipic acid (40.0 g) was introduced and the temperature was maintained between 215° C. and 225° C. The water produced was distilled until an acid number of less than 20 mg KOH/g was obtained. Dehydrated castor fatty acid (130.0 g) was introduced. The water produced was distilled and the temperature was maintained between 215° C. and 225° C. until an acid number of less than 20 mg KOH/g was obtained.

### Example 6: Preparation of a Polyester Polyol PE3(a)

Pentaerythritol (242.15 g), benzoic acid (385.69 g) and dehydrated castor fatty acid (537.41 g) were introduced into a reactor equipped with a distillation column and an inclined-blade stirrer. The reaction mixture was heated to between 230° C. and 240° C. The water formed in the reaction was distilled until an acid number of less than 5 mg KOH/g was obtained.

### Example 7: Preparation of a Polyester Polyol PE3(b)

Trimethylolpropane (146.34 g), benzoic acid (81.27 g), phthalic anhydride (56.81 g) and dehydrated castor fatty acid (250.00 g) were introduced into a reactor equipped with a distillation column and an inclined-blade stirrer. The reaction mixture was heated to between 230° C. and 240° C. The water formed in the reaction was distilled until an acid number of less than 5 mg KOH/g was obtained.

### Example 8: Preparation of a Poly(Ester-Urea-Urethane) with a PE1

The PE1(a) of example 5 (75.0 g) was mixed with IPDI (25.23 g). The mixture was heated to 110° C. while controlling the exothermicity. The temperature was maintained until the isocyanate number was less than 65 mg KOH/g. The temperature was reduced to 95° C. The product obtained was emulsified by adding distilled water (140.0 g) while stirring at a speed of 300 rpm and while maintaining the temperature at 95° C. (water introduction rate=140 g/hour). The emulsion was maintained at 95° C. until an isocyanate number of less than 2 mg KOH/g was obtained. The OH number is 0 mg KOH/g.

### Example 9: Preparation of a Poly(Ester-Urea-Urethane) with a PE2 and a PE3

The various reactants used in this example are described in the table below. A polyester polyol PE2 (25.0 g) was heated to 110° C., and then introduced into a reactor containing IPDI (25.52 g) at 80° C. The mixture was heated to 110° C. while controlling the exothermicity. The temperature was maintained at 110° C. for 1 hour. A polyester polyol PE3 (50.0 g) was then introduced within 1 hour (introduction rate=50 g/hour). The reaction medium was maintained at 110° C. until an isocyanate number of less than 50 mg KOH/g was obtained. The temperature was reduced to 95° C. The product obtained was emulsified by adding distilled water (145.0 g) while stirring at a speed of 300 rpm and while maintaining the temperature at 95° C. (water introduction rate=14.5 g/min). After introduction of the water, the temperature of the emulsion was lowered to 40° C. The isocyanate number (I_{NCO}) was measured (in mg KOH/g) in order to calculate the mass of polyamine required for the elongation reaction. The polyamine was then added to the reaction mixture and the reaction was maintained under stirring until an isocyanate number of less than 2 mg KOH/g was obtained. The OH number is 0 mg KOH/g.

| Ex- | | | | Calculation | Poly- |
|---|---|---|---|---|---|
| am- | | | | of | amine |
| ple | | | | polyamine | mass |
| No. | PE2 | PE3 | Polyamine | mass | (grams) |
| 9.1 | PE2(a) of | PE3(a) of | ethylenediamine | I_{NCO}*0.105 | 1.80 |
| | example 1 | example 6 | | | |
| 9.2 | PE2(a) of | PE3(a) of | diethylenetriamine | I_{NCO}*0.120 | 2.06 |
| | example 1 | example 6 | | | |
| 9.3 | PE2(a) of | PE3(a) of | tetraethylenepentamine | I_{NCO}*0.132 | 2.27 |
| | example 1 | example 6 | | | |
| 9.4 | PE2(b) of | PE3(a) of | tetraethylenepentamine | I_{NCO}*0.132 | 2.27 |
| | example 2 | example 6 | | | |
| 9.5 | PE2(b) of | PE3(b) of | tetraethylenepentamine | I_{NCO}*0.132 | 2.27 |
| | example 2 | example 7 | | | |
| 9.6 | PE2(c) of | PE3(a) of | diethylenetriamine | I_{NCO}*0.120 | 2.06 |
| | example 3 | example 6 | | | |
| 9.7 | PE2(d) of | PE3(b) of | tetraethylenepentamine | I_{NCO}*0.132 | 2.27 |
| | example 4 | example 7 | | | |

### Example 10: Properties of the Poly(Ester-Urea-Urethanes) Prepared

The poly(ester-urea-urethanes) of examples 8 and 9 were applied to a glass sheet using a film spreader to form a layer having a wet thickness of around 100 μm. The film was dried under a nitrogen atmosphere for 12 h at ambient temperature (20-25° C.).

The Persoz hardness was measured 2 h, 4 h, 9 h and 24 h after application according to the method described above.

| | Persoz hardness (number of strokes) | | | |
|---|---|---|---|---|
| Example No. | 2 h | 4 h | 9 h | 24 h |
| Example 8 | 67 | 85 | 100 | 120 |
| Example 9.1 | 205 | 220 | 235 | 245 |
| Example 9.2 | 204 | 215 | 218 | 221 |
| Example 9.3 | 227 | 243 | 246 | 255 |
| Example 9.4 | 126 | 140 | 178 | 202 |
| Example 9.5 | 136 | 158 | 185 | 199 |
| Example 9.6 | 123 | 143 | 156 | 180 |
| Example 9.7 | 142 | 151 | 159 | 179 |

The poly(ester-urea-urethanes) according to the invention exhibit an excellent Persoz hardness. In addition, the hardness develops rapidly since the coatings have a good hardness after only 2 hours after their application.

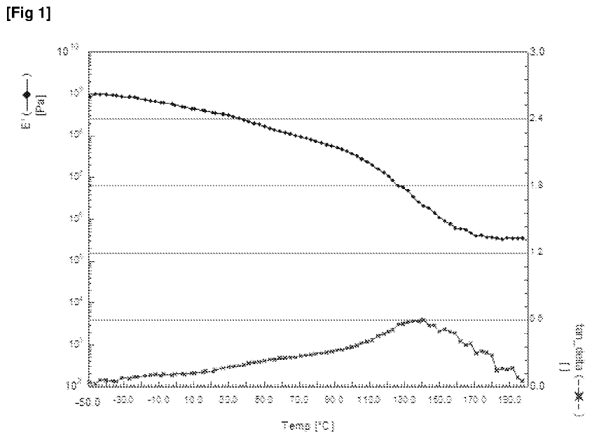

The DMA curve (FIG. 1) shows that the film after drying obtained with the poly(ester-urea-urethane) of example 9.3 is in crosslinked form without the addition of an external siccative agent.

### Example 11: Preparation of a Polyester Polyol

Neopentyl glycol (141.91 g) was heated to 165° C. in a reactor equipped with a distillation column and an inclined-blade stirrer. Dimethyl sulfoisophthalate sodium salt was introduced (77.31 g). BuSnOOH (0.050 g) was introduced. The temperature was raised and then maintained for 1 hour between 195° C. and 205° C. The methanol formed in the reaction was distilled. Adipic acid (114.42 g) was then introduced and the reaction medium was maintained between 175° C. and 185° C. The water formed in the reaction was distilled until an acid number of less than 12 mg KOH/g was obtained.

### Example 12: Preparation of a Polyester Polyol

Neopentyl glycol (141.91 g) was heated to 165° C. in a reactor equipped with a distillation column and an inclined-blade stirrer. Dimethyl sulfoisophthalate sodium salt was introduced (77.31 g). BuSnOOH (0.050 g) was introduced. The temperature was raised and then maintained for 1 hour between 195° C. and 205° C. The methanol formed in the reaction was distilled. Diethyl malonate (130.82 g) was then introduced and the reaction medium was maintained at between 175° C. and 185° C. for 8 hours. The ethanol formed in the reaction was distilled.

### Example 13: Preparation of a Polyester Polyol

Neopentyl glycol (249.19 g) and adipic acid (314.34 g) were heated to 165° C. in a reactor equipped with a distillation column and an inclined-blade stirrer. The temperature was raised and then maintained between 210° C. and 220° C. The water formed in the reaction was distilled until an acid number of less than 10 mg KOH/g was obtained.

### Example 14: Preparation of a Polyester Polyol

Neopentyl glycol (249.19 g) and diethyl malonate (354.85 g) were heated to 180° C. in a reactor equipped with a distillation column and an inclined-blade stirrer. BuSnOOH (0.100 g) was introduced and the reaction medium was maintained at between 175° C. and 185° C. for 16 hours. The ethanol formed in the reaction was distilled.

### Example 15: Preparation of a Poly(Ester-Urea-Urethane)

The polyester polyol of example 11 (25.0 g) was heated to 110° C., and then introduced into a reactor containing IPDI (25.52 g) at 80° C. The mixture was heated to 110° C. while controlling the exothermicity. The temperature was maintained at 110° C. for 30 minutes. Octanol (Aldrich) (12.75 g) was then introduced. The reaction medium was maintained at 110° C. until an isocyanate number of less than 70 mg KOH/g was obtained. The temperature was reduced to 95° C. The product obtained was emulsified by adding distilled water (90.0 g) outside of the heating system while stirring at a speed of 300 rpm and while maintaining the temperature at 95° C. (water introduction rate=9.0 g/min). After introduction of the water, the temperature of the emulsion was lowered and maintained at 40° C. The isocyanate number (I_{NCO}) was measured at 18.0 mg KOH/g. The tetraethylenepentamine (1.49 g) was then added to the reaction mixture and the reaction was maintained under stirring until an isocyanate number of less than 2 mg KOH/g was obtained. The OH number is 0 mg KOH/g.

### Example 16: Preparation of a Poly(Ester-Urea-Urethane)

The polyester polyol of example 11 (25.0 g) was heated to 110° C., and then introduced into a reactor containing IPDI (25.52 g) at 80° C. The mixture was heated to 110° C. while controlling the exothermicity. The temperature was maintained at 110° C. for 30 minutes. Octanol (Aldrich) (4.15 g) and the polyester polyol of example 13 (45.85 g) were introduced. The reaction medium was maintained at 110° C. until an isocyanate number of less than 50 mg KOH/g was obtained. The temperature was reduced to 95° C. The product obtained was emulsified by adding distilled water (140.0 g) outside of the heating system while stirring at a speed of 300 rpm and while maintaining the temperature at 95° C. (water introduction rate=14.0 g/min). After introduction of the water, the temperature of the emulsion was lowered and maintained at 40° C. The isocyanate number (I_{NCO}) was measured at 13.8 mg KOH/g. The tetraethylenepentamine (1.79 g) was then added to the reaction mixture and the reaction was maintained under stirring until an isocyanate number of less than 2 mg KOH/g was obtained. The OH number is 0 mg KOH/g.

### Example 17: Preparation of a Poly(Ester-Urea-Urethane)

The polyester polyol of example 12 (25.0 g) was heated to 110° C., and then introduced into a reactor containing IPDI (25.52 g) at 80° C. The mixture was heated to 110° C. while controlling the exothermicity. The temperature was maintained at 110° C. for 30 minutes. Octanol (Aldrich) (4.15 g) and the polyester of example 14 (45.85 g) were introduced. The reaction medium was maintained at 110° C. until an isocyanate number of less than 50 mg KOH/g was obtained. The temperature was reduced to 95° C. The product obtained was emulsified by adding distilled water (140.0 g) outside of the heating system while stirring at a speed of 300 rpm and while maintaining the temperature at 95° C. (water introduction rate=14.0 g/min). After introduction of the water, the temperature of the emulsion was lowered and maintained at 40° C. The isocyanate number (I_{NCO}) was measured at 14.1 mg KOH/g. The tetraethylenepentamine (1.83 g) was then added to the reaction mixture and the reaction was maintained under stirring until an isocyanate number of less than 2 mg KOH/g was obtained. The OH number is 0 mg KOH/g.

1. A poly(ester-urethane), comprising:
isocyanate functions;
acid groups having a pKa of less than 3, optionally in partially or completely neutralized form;
optionally saturated fatty chains and/or unsaturated fatty chains;
ester and urethane bonds;
optionally an amide bond; and
optionally a urea bond.

2. The poly(ester-urethane) as claimed in claim 1, having one or more features chosen from:
a number-average molecular mass Mn of from 250 to 10 000 g/mol;
an NCO number of from 20 to 250 mg KOH/g;
an OH number of less than 20 mg KOH/g;
the saturated fatty chains and/or unsaturated fatty chains represent 0% or at least 5% of the total weight of the poly(ester-urethane);
comprising less than 10% by weight of solvent;
comprising less than 10% by weight of volatile amine.

3. The poly(ester-urethane) as claimed in claim 1 comprising saturated fatty chains and/or unsaturated fatty chains.

4. The poly(ester-urethane) as claimed in claim 3, wherein the saturated fatty chains and/or unsaturated fatty chains represent at least 5% of the total weight of the poly(ester-urethane).

5. The poly(ester-urethane) as claimed in claim 1 wherein the saturated fatty chains and/or unsaturated fatty chains represent 0% of the total weight of the poly(ester-urethane).

6. The poly(ester-urethane) as claimed in claim 1 wherein the acid groups having a pKa of less than 3 are chosen from a sulfonylated group (—S(═O)2OR), a phosphonylated group (—P(═O)(OR)2), a sulfated group (—O—S(═O)2OR), a phosphated group (—O—P(═O)(OR)2), and mixtures thereof, each R independently being a hydrogen atom, a metal salt or a hydrocarbyl chain.

7. The poly(ester-urethane) as claimed in claim 1 obtained by:
polyaddition of at least one polyisocyanate, at least one polyol P1 and optionally another polyol P4 and/or a fatty component CG, said polyol P1 comprising an acid group having a pKa of less than 3, optionally in partially or completely neutralized form, optionally a saturated fatty chain and/or an unsaturated fatty chain and optionally an amine function; or by
polyaddition of at least one polyisocyanate, at least one polyol P2, at least one polyol P3 and optionally another polyol P4 and/or a fatty component CG, said polyol P2 comprising an acid group having a pKa of less than 3, optionally in partially or completely neutralized form, and optionally an amine function, said polyol P3 comprising a saturated fatty chain and/or an unsaturated fatty chain and optionally an amine function;
in which the polyaddition is effected with a molar ratio of the functions NCO/(OH+optional amine) of greater than 1.

8. The poly(ester-urethane) as claimed in claim 7, wherein the polyaddition is carried out in the absence of solvent.

9. The poly(ester-urethane) as claimed in claim 7 wherein polyol P1, the polyol P2 and the polyol P3 are polyester polyols, P1, P2 and/or P3 optionally comprise an element chosen from an amine function, an amide bond, a urethane bond, and combinations thereof.

10. A poly(ester-urea-urethane) comprising:
acid groups having a pKa of less than 3, optionally in partially or completely neutralized form;
optionally saturated fatty chains and/or unsaturated fatty chains;
ester, urea and urethane bonds; and
optionally an amide bond.

11. The poly(ester-urea-urethane) as claimed in claim 10 having one or more of the following properties:
an amine number of less than 20 mg KOH/g;
an OH number of less than 120 mg KOH/g;
the saturated fatty chains and/or unsaturated fatty chains represent 0% or at least 5% of the total weight of the poly(ester-urea-urethane);
comprising less than 10% by weight of solvent other than water;
comprising less than 10% by weight of volatile amine;
comprising less than 2% by weight of metal-based urethanization catalyst;
wherein the poly(ester-urea-urethane) is optionally crosslinked.

12. The poly(ester-urea-urethane) as claimed in claim 10 comprising saturated fatty chains and/or unsaturated fatty chains.

13. The poly(ester-urea-urethane) as claimed in claim 12, wherein the saturated fatty chains and/or unsaturated fatty chains represent at least 5% of the total weight of the poly(ester-urea-urethane).

14. The poly(ester-urea-urethane) as claimed in claim 10 wherein the saturated fatty chains and/or unsaturated fatty chains represent 0% of the total weight of the poly(ester-urea-urethane).

15. The poly(ester-urea-urethane) as claimed in claim 10 wherein the poly(ester-urea-urethane) is crosslinked.

16. The poly(ester-urea-urethane) as claimed in claim 10 obtained by elongation reaction of poly(ester-urethane) in water, said poly(ester-urethane) comprising:
isocyanate functions;
acid groups having a pKa of less than 3, optionally in partially or completely neutralized form;
optionally saturated fatty chains and/or unsaturated fatty chains;
ester and urethane bonds;
optionally an amide bond; and
optionally a urea bond;
optionally in the presence of a polyamine component having a functionality ranging from 2 to 6, the molar ratio between the amine functions of the optional polyamine component and the isocyanate functions of the poly(ester-urethane) being from 0.01 to 3.

17. The poly(ester-urea-urethane) as claimed in claim 16 obtained by elongation reaction of the poly(ester-urethane) in water in the presence of a polyamine component having a functionality ranging from 2.25 to 6.

18. An aqueous dispersion comprising the poly(ester-urethane) as claimed in claim 1, the acid groups of the poly(ester-urethane) being in partially or completely neutralized form.

19. The aqueous dispersion as claimed in claim 18 comprising particles and having one or more of the following properties:
comprising less than 10%, by weight of solvent other than water;
comprising less than 10%, by weight of additional surfactant;
comprising less than 2%, by weight of metal-based urethanization catalyst;
a solids content of from 5 to 70%;
a pH of from 5 to 9;
a viscosity at 25° C. of from 1 to 10 000 mPa·s;
the particles having an average size of from 10 to 1000 nm;
wherein the poly(ester-urea-urethane) is optionally crosslinked.

20. The aqueous dispersion as claimed in claim 18 wherein the poly(ester-urea-urethane) is crosslinked.

21. The aqueous dispersion as claimed in claim 18 obtained by a process comprising the following steps:
preparing at least one polyol P1 or preparing at least one polyol P2 and at least one polyol;
preparing a poly(ester-urethane) by polyaddition of at least one polyisocyanate, at least one polyol P1 and optionally another polyol P4 and/or a fatty component CG or by polyaddition of at least one polyisocyanate, at least one polyol P2, at least one polyol P3 and optionally another polyol P4 and/or a fatty component CG, the polyaddition being effected with a molar ratio of the functions NCO/(OH+optional amine) of greater than 1;
optionally partially or completely neutralizing the acid groups of the poly(ester-urethane) by addition of a base;
dispersing the poly(ester-urethane) in water;
optionally conducting an elongation reaction of the poly(ester-urethane), optionally in the presence of a polyamine component having a functionality ranging from 2 to 6, the molar ratio between the amine functions of the optional polyamine component and the isocyanate functions of the poly(ester-urethane) being from 0.01 to 3.

22. The aqueous dispersion as claimed in claim 21 obtained by a process comprising an elongation reaction of the poly(ester-urethane) in the presence of a polyamine component having a functionality ranging from 2.25 to 6.

23. A coating, adhesive or sealant composition comprising a poly(ester-urethane) as defined in claim 1.

24. (canceled)

25. (canceled)
